(19) United States
(12) Patent Application Publication
(10) Pub. No.: US 2025/0252350 A1
(43) Pub. Date: Aug. 7, 2025

(54) OVER-THE-AIR AGGREGATION FEDERATED LEARNING WITH NON-CONNECTED DEVICES

(71) Applicant: QUALCOMM INCORPORATED, San Diego, CA (US)

(72) Inventors: Stelios Stefanatos, San Diego, CA (US); Shuanshuan Wu, San Diego, CA (US); Arthur Gubeskys, San Diego, CA (US); Anantharaman Balasubramanian, San Diego, CA (US)

(21) Appl. No.: 18/864,431

(22) PCT Filed: Jul. 31, 2023
(86) PCT No.: PCT/US2023/071365

§ 371 Date: Nov. 8, 2024

(30) Foreign Application Priority Data
Aug. 4, 2022 (GR) 20220100644

(51) Int. Cl. G06N 20/00

(52) U.S. Cl. CPC G06N 20/00

(57) ABSTRACT

Methods, systems, and devices for wireless communications are described. A user equipment (UE) may receive a first message requesting the UE to perform a federated learning procedure. The first message may indicate a machine learning model and a configuration for the federated learning procedure. The UE may perform, in response to the first message, a training procedure using the machine learning model to obtain one or more model parameters based on the configuration for the federated learning procedure. The UE may transmit a second message indicating one or more gradient values for the one or more model parameters via one or more resources configured for over-the-air (OTA) aggregation based on the configuration for the federated learning procedure.

### CROSS REFERENCE

The present Application is a 371 national stage filing of International PCT Application No. PCT/US2023/071365 by Stefanatos et al. entitled “OVER-THE-AIR AGGREGATION FEDERATED LEARNING WITH NON-CONNECTED DEVICES,” filed Jul. 31, 2023; and claims priority to Greek Patent Application No. 20220100644 by Stefanatos et al. entitled “OVER-THE-AIR AGGREGATION FEDERATED LEARNING WITH NON-CONNECTED DEVICES,” filed Aug. 4, 2022, each of which is assigned to the assignee hereof, and each of which is expressly incorporated by reference in its entirety herein.

### FIELD OF TECHNOLOGY

The following relates to wireless communications, including over-the-air (OTA) aggregation federated learning with non-connected devices.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support over-the-air (OTA) aggregation federated learning with non-connected devices. For example, the described techniques provide for user equipment (UE) operating in a non-connected mode to participate (e.g., optionally participate) in a training round for federated learning. A server for the federated learning procedure may transmit an invitation message that requests for clients (e.g., UEs) to participate in a training round for a federated learning procedure. The invitation message may indicate a machine learning model and a configuration for the federated learning procedure. The UE may locally train the machine learning model based on a dataset collected by the UE to obtain model parameters for the machine learning model. The UE may transmit gradient values for the model parameters on one or more resources configured for OTA aggregation based on the configuration for the federated learning procedure. In some examples, the invitation message may indicate a power control configuration for transmitting the gradient values on the one or more resources configured for OTA aggregation.

A method for wireless communications at a UE is described. The method may include receiving a first message requesting the UE to perform a federated learning procedure, the first message indicating a machine learning model and a configuration for the federated learning procedure, performing, in response to the first message requesting the UE to perform the federated learning procedure, a training procedure using the machine learning model to obtain one or more model parameters based on the configuration for the federated learning procedure, and transmitting a second message indicating one or more gradient values for the one or more model parameters via one or more resources configured for OTA aggregation based on the configuration for the federated learning procedure.

An apparatus for wireless communications at a UE is described. The apparatus may include a processor, memory coupled with the processor, and one or more instructions stored in the memory. The one or more instructions may be executable by the processor to cause the apparatus to receive a first message requesting the UE to perform a federated learning procedure, the first message indicating a machine learning model and a configuration for the federated learning procedure, perform, in response to the first message requesting the UE to perform the federated learning procedure, a training procedure using the machine learning model to obtain one or more model parameters based on the configuration for the federated learning procedure, and transmit a second message indicating one or more gradient values for the one or more model parameters via one or more resources configured for OTA aggregation based on the configuration for the federated learning procedure.

Another apparatus for wireless communications at a UE is described. The apparatus may include means for receiving a first message requesting the UE to perform a federated learning procedure, the first message indicating a machine learning model and a configuration for the federated learning procedure, means for performing, in response to the first message requesting the UE to perform the federated learning procedure, a training procedure using the machine learning model to obtain one or more model parameters based on the configuration for the federated learning procedure, and means for transmitting a second message indicating one or more gradient values for the one or more model parameters via one or more resources configured for OTA aggregation based on the configuration for the federated learning procedure.

A non-transitory computer-readable medium storing code for wireless communications at a UE is described. The code may include instructions executable by a processor to receive a first message requesting the UE to perform a federated learning procedure, the first message indicating a machine learning model and a configuration for the federated learning procedure, perform, in response to the first message requesting the UE to perform the federated learning procedure, a training procedure using the machine learning model to obtain one or more model parameters based on the configuration for the federated learning procedure, and transmit a second message indicating one or more gradient values for the one or more model parameters via one or more resources configured for OTA aggregation based on the configuration for the federated learning procedure.

In some examples of the method, apparatuses, and non-transitory computer-readable medium described herein, receiving the first message may include operations, features, means, or instructions for receiving the first message indicating a range associated with participating in the federated learning procedure, where transmitting the second message may be based on determining the UE may be within the range.

In some examples of the method, apparatuses, and non-transitory computer-readable medium described herein, receiving the first message may include operations, features, means, or instructions for receiving the first message indicating a reference signal and a threshold and measuring the reference signal to obtain a measurement of the reference signal, where transmitting the second message may be based on the measurement of the reference signal exceeding the threshold.

In some examples of the method, apparatuses, and non-transitory computer-readable medium described herein, receiving the first message may include operations, features, means, or instructions for receiving the first message indicating a nominal transmit power for transmitting the second message on the one or more resources configured for the OTA aggregation, where transmitting the second message may be based on the nominal transmit power.

Some examples of the method, apparatuses, and non-transitory computer-readable medium described herein may further include operations, features, means, or instructions for receiving an indication of a path loss reference signal and an indication of a reference signal power value and measuring the path loss reference signal, where transmitting the second message may be based on a measurement of the path loss reference signal and the reference signal power value.

Some examples of the method, apparatuses, and non-transitory computer-readable medium described herein may further include operations, features, means, or instructions for receiving an indication of a location of a server and determining a path loss estimate for the second message based on a distance between the UE and the location of the server and a path loss model, where transmitting the second message may be based on the path loss estimate.

In some examples of the method, apparatuses, and non-transitory computer-readable medium described herein, receiving the first message may include operations, features, means, or instructions for receiving an indication of the machine learning model from a set of multiple machine learning models.

In some examples of the method, apparatuses, and non-transitory computer-readable medium described herein, receiving the first message may include operations, features, means, or instructions for receiving an indication of a quantity of layers in a set of multiple layers for the machine learning model, a size of each layer of the set of multiple layers, an order of the set of multiple layers, a connectivity of the set of multiple layers, or any combination thereof, where performing the training procedure may be based on the quantity of layers, the size of each layer of the set of multiple layers, the order of the set of multiple layers, the connectivity of the set of multiple layers, or any combination thereof.

In some examples of the method, apparatuses, and non-transitory computer-readable medium described herein, receiving the first message may include operations, features, means, or instructions for receiving an indication of a version of the machine learning model from a set of multiple versions of the machine learning model, where performing the training procedure may be based on the version of the machine learning model.

In some examples of the method, apparatuses, and non-transitory computer-readable medium described herein, receiving the first message may include operations, features, means, or instructions for receiving an indication of an OTA aggregation scheme from a set of multiple OTA aggregation schemes.

Some examples of the method, apparatuses, and non-transitory computer-readable medium described herein may further include operations, features, means, or instructions for receiving an indication of a set of multiple occasions in one or more paging frames for the first message requesting the UE to perform the federated learning procedure and monitoring for the first message based on the indication of the set of multiple occasions for the first message.

Some examples of the method, apparatuses, and non-transitory computer-readable medium described herein may further include operations, features, means, or instructions for receiving a wakeup signal associated with the first message and monitoring for the first message requesting the UE to perform the federated learning procedure based on receiving the wakeup signal.

Some examples of the method, apparatuses, and non-transitory computer-readable medium described herein may further include operations, features, means, or instructions for decoding the first message based on a paging radio network temporary identifier and detecting one or more fields in the first message corresponding to the federated learning procedure, where performing the training procedure may be based on detecting the one or more fields.

Some examples of the method, apparatuses, and non-transitory computer-readable medium described herein may further include operations, features, means, or instructions for decoding the first message based on a radio network temporary identifier associated with the federated learning procedure, where performing the training procedure may be based on decoding the first message based on the radio network temporary identifier associated with the federated learning procedure.

In some examples of the method, apparatuses, and non-transitory computer-readable medium described herein, receiving the first message may include operations, features, means, or instructions for receiving the first message during a paging frame or occasion associated with the federated learning procedure, where performing the training procedure may be based on receiving the first message during the paging frame or occasion associated with the federated learning procedure.

In some examples of the method, apparatuses, and non-transitory computer-readable medium described herein, receiving the first message may include operations, features, means, or instructions for receiving a broadcast transmission or a groupcast transmission on a sidelink channel including sidelink control information requesting the UE to perform the federated learning procedure.

In some examples of the method, apparatuses, and non-transitory computer-readable medium described herein, receiving the first message may include operations, features, means, or instructions for receiving the first message indicating one or more criteria for participating in the federated learning procedure, where the one or more criteria may be based on a version for the machine learning model, a minimum local dataset size, an acquisition time for a local dataset at the UE, or any combination thereof.

In some examples of the method, apparatuses, and non-transitory computer-readable medium described herein, transmitting the second message may include operations, features, means, or instructions for transmitting the second message via the one or more resources configured for transmission by a set of multiple UEs including the UE, where the set of multiple UEs may be scheduled to transmit respective sets of gradient values via the one or more resources in accordance with a common transmit power.

Some examples of the method, apparatuses, and non-transitory computer-readable medium described herein may further include operations, features, means, or instructions for receiving a third message indicating an updated version for the machine learning model based on the one or more gradient values for the one or more model parameters and updating the machine learning model based on the updated version for the machine learning model.

Some examples of the method, apparatuses, and non-transitory computer-readable medium described herein may further include operations, features, means, or instructions for receiving a third message indicating a same version model for the machine learning model and a scalar probability threshold for participating in the federated learning procedure, determining to perform the federated learning procedure based on a randomly generated value satisfying the scalar probability threshold, performing the training procedure using the machine learning model to obtain a second one or more model parameters based on the configuration for the federated learning procedure and the randomly generated value satisfying the scalar probability threshold, and transmitting a fourth message indicating a second one or more gradient values for the second one or more model parameters based on the configuration for the federated learning procedure.

In some examples of the method, apparatuses, and non-transitory computer-readable medium described herein, the UE may be operating in an inactive state or an idle state.

In some examples of the method, apparatuses, and non-transitory computer-readable medium described herein, receiving the first message may include operations, features, means, or instructions for receiving the first message configuring the UE to transmit the one or more model parameters in the second message, where the second message indicates the one or more model parameters.

A method for wireless communications at a wireless device is described. The method may include transmitting a first message requesting a set of multiple UEs to perform a federated learning procedure, the first message indicating a machine learning model and a configuration for the federated learning procedure, receiving a set of multiple second messages indicating a set of multiple sets of gradient values for a set of multiple sets of one or more model parameters via one or more resources configured for OTA aggregation based on the configuration for the federated learning procedure, and training the machine learning model using the set of multiple sets of one or more model parameters.

An apparatus for wireless communications at a wireless device is described. The apparatus may include a processor, memory coupled with the processor, and one or more instructions stored in the memory. The one or more instructions may be executable by the processor to cause the apparatus to transmit a first message requesting a set of multiple UEs to perform a federated learning procedure, the first message indicating a machine learning model and a configuration for the federated learning procedure, receive a set of multiple second messages indicating a set of multiple sets of gradient values for a set of multiple sets of one or more model parameters via one or more resources configured for OTA aggregation based on the configuration for the federated learning procedure, and train the machine learning model using the set of multiple sets of one or more model parameters.

Another apparatus for wireless communications at a wireless device is described. The apparatus may include means for transmitting a first message requesting a set of multiple UEs to perform a federated learning procedure, the first message indicating a machine learning model and a configuration for the federated learning procedure, means for receiving a set of multiple second messages indicating a set of multiple sets of gradient values for a set of multiple sets of one or more model parameters via one or more resources configured for OTA aggregation based on the configuration for the federated learning procedure, and means for training the machine learning model using the set of multiple sets of one or more model parameters.

A non-transitory computer-readable medium storing code for wireless communications at a wireless device is described. The code may include instructions executable by a processor to transmit a first message requesting a set of multiple UEs to perform a federated learning procedure, the first message indicating a machine learning model and a configuration for the federated learning procedure, receive a set of multiple second messages indicating a set of multiple sets of gradient values for a set of multiple sets of one or more model parameters via one or more resources configured for OTA aggregation based on the configuration for the federated learning procedure, and train the machine learning model using the set of multiple sets of one or more model parameters.

In some examples of the method, apparatuses, and non-transitory computer-readable medium described herein, transmitting the first message may include operations, features, means, or instructions for transmitting the first message indicating a range associated with participating in the federated learning procedure, where the set of multiple second messages may be received from UEs within the range.

In some examples of the method, apparatuses, and non-transitory computer-readable medium described herein, transmitting the first message may include operations, features, means, or instructions for transmitting an indication of the machine learning model from a set of multiple machine learning models, a version of the machine learning model from a set of multiple versions of the machine learning model, an OTA aggregation scheme from a set of multiple OTA aggregation schemes, a federated learning procedure from a set of multiple federated learning procedures, or any combination thereof.

In some examples of the method, apparatuses, and non-transitory computer-readable medium described herein, transmitting the first message may include operations, features, means, or instructions for transmitting an indication of a quantity of layers in a set of multiple layers for the machine learning model, a size of each layer of the set of multiple layers, an order of the set of multiple layers, a connectivity of the set of multiple layers, or any combination thereof.

Some examples of the method, apparatuses, and non-transitory computer-readable medium described herein may further include operations, features, means, or instructions for transmitting a third message indicating an updated version for the machine learning model based on training the machine learning model and receiving a set of multiple fourth messages indicating a second set of multiple sets of gradient values for a second set of multiple sets of one or more model parameters via the one or more resources configured for OTA aggregation based on the configuration for the federated learning procedure.

Some examples of the method, apparatuses, and non-transitory computer-readable medium described herein may further include operations, features, means, or instructions for determining a training of the machine learning model using the second set of multiple sets of one or more model parameters may be unsuccessful based on an excessive received power of the set of multiple fourth messages and transmitting a fifth message requesting the set of multiple UEs to perform the federated learning procedure, the fifth message indicating the updated version for the machine learning model and a reduced nominal UE transmit power.

### BRIEF DESCRIPTION OF THE DRAWINGS

FIG. 1 illustrates an example of a wireless communications system that supports over-the-air (OTA) aggregation federated learning with non-connected devices in accordance with one or more aspects of the present disclosure.

FIG. 2 illustrates an example of a wireless communications system that supports OTA aggregation federated learning with non-connected devices in accordance with one or more aspects of the present disclosure.

FIG. 3 illustrates an example of a process flow that supports OTA aggregation federated learning with non-connected devices in accordance with one or more aspects of the present disclosure.

FIG. 4 illustrates an example of a process flow that supports OTA aggregation federated learning with non-connected devices in accordance with one or more aspects of the present disclosure.

FIGS. 5 and 6 show block diagrams of devices that support OTA aggregation federated learning with non-connected devices in accordance with one or more aspects of the present disclosure.

FIG. 7 shows a block diagram of a communications manager that supports OTA aggregation federated learning with non-connected devices in accordance with one or more aspects of the present disclosure.

FIG. 8 shows a diagram of a system including a device that supports OTA aggregation federated learning with non-connected devices in accordance with one or more aspects of the present disclosure.

FIGS. 9 and 10 show block diagrams of devices that support OTA aggregation federated learning with non-connected devices in accordance with one or more aspects of the present disclosure.

FIG. 11 shows a block diagram of a communications manager that supports OTA aggregation federated learning with non-connected devices in accordance with one or more aspects of the present disclosure.

FIG. 12 shows a diagram of a system including a device that supports OTA aggregation federated learning with non-connected devices in accordance with one or more aspects of the present disclosure.

FIGS. 13 through 17 show flowcharts illustrating methods that support OTA aggregation federated learning with non-connected devices in accordance with one or more aspects of the present disclosure.

### DETAILED DESCRIPTION

A wireless communications system may support a federated learning procedure to train a machine learning model. For a federated learning procedure, multiple clients, such as user equipment (UE), may employ a same machine learning model structure and locally train model parameters for the machine learning model based on local observations or data. The clients may send information for updated model parameters to a server, which compiles the information from all of the clients to determine global or aggregated model parameters. The server may then send the updated model parameters, or an updated machine learning model, to the clients. The federated learning procedure may include multiple training rounds, each of which may be dynamically scheduled by the server. The server may receive the information for the model parameters, update the machine learning model, and transmit information for an updated version of the machine learning model to the clients for another round of the federated learning procedure.

Some wireless communications systems may use over-the-air (OTA) aggregation techniques to reduce overhead for clients reporting information for the locally-updated, or locally-trained, model parameters. A machine learning model may have a large number of parameters (e.g., tens or hundreds of thousands of parameters), and each client individually reporting the machine learning model parameters may have significant overhead. To reduce the overhead, the clients may transmit gradients for the locally-trained model parameters on a same set of resources. For example, each gradient (e.g., corresponding to one model parameter) may be mapped to a respective resource element. Each client may transmit a locally computed analog gradient values corresponding to a model parameter over a same resource element (e.g., corresponding to that model parameter or gradient). A receiver, such as the server, may observe the superposition of the transmitted gradient values, which may correspond to averages of the gradient values for the model parameters. The receiver may determine average values for the model parameters from all clients participating in the federated learning procedure and use the average values for the model parameters to update the machine learning model values.

In some systems implementing OTA aggregation for a federated learning procedure, each client may perform power control techniques to ensure that the gradient values from all clients are received with a same power. These power control techniques may prevent near-far effects which may over-represent data reported from clients closer to the receiver or clients experiencing smaller path loss when OTA aggregation of gradients is performed. For example, UEs which are closer to the receiver may reduce transmit power compared to farther away UEs, such that information received at the receiver from each UE has a same average power. Therefore, some systems may support only UEs operating in a Radio Resource Control (RRC) connected mode to participate in a federated learning procedure which uses OTA aggregation, as RRC-connected UEs may apply default power control configurations. However, this may reduce the potential information gathered for the federated learning procedure and slow the training procedure for the machine learning model.

Techniques described herein support a federated learning procedure for non-connected UEs using OTA aggregation. These techniques may enable non-connected UEs, such as UEs operating in an RRC idle or RRC inactive state, to participate in one or more training rounds, sessions, or procedures for federated learning using OTA aggregation without switching to an RRC connected mode, which may reduce overhead and delay from the RRC establishment procedure. A server, such as a network entity or a UE, may transmit an invitation message prior to a federated learning procedure. The invitation message may invite, or request, UEs (e.g., operating in an RRC connected state or a non-connected state) to participate in the upcoming round of the federated learning procedure. The invitation message may indicate a configuration, or a set of one or more parameters, for the federated learning procedure. For example, the invitation message may indicate a machine learning model, an OTA aggregation scheme, resources for OTA aggregation, and the like. In some examples, the invitation message may indicate power control instructions for reporting gradient values for model parameters. Indicating the power control instructions may enable non-RRC connected UEs to report the gradient values such that the gradient values are received with a same power as other UEs participating in the federated learning procedure. In some examples, the invitation message may be a system information block (SIB) message and may be received or read by any UE 115.

A UE that receives the invitation message may determine whether to participate in the federated learning training round. If the UE determines to participate in the federated learning training round, the UE may implement power control in accordance with the indicated power control instructions of the invitation message. In some cases, a UE may participate in the federated learning training ground without transmitting an announcement message that the UE is participating. The UEs participating in the federated learning training round may perform a training procedure using the machine learning model to determine parameters for the machine learning model, and the UEs may implement the power control instructions while transmitting gradients of the machine learning models on the resources configured for OTA aggregation.

The power control instructions for the federated learning procedure may be based on distance from the server or path loss, or both. For example, the invitation message may indicate a distance from the server, and UEs within the distance from the server may participate in the training round. Additionally, or alternatively, the invitation message may indicate a reference signal and a power threshold (e.g., a reference signal received power (RSRP) threshold). The UEs may measure an RSRP of the reference signal, and UEs with an RSRP measurement of the reference signal that satisfy the power threshold may participate in the federated learning procedure or the upcoming training round for the federated learning procedure. In some examples, the invitation message may indicate a nominal UE transmit power that UEs participating in the training round are to apply when transmitting the gradient values of the model parameters. Some additional, or alternative, techniques for power control are described herein.

Aspects of the disclosure are initially described in the context of wireless communications systems. Aspects of the disclosure are further illustrated by and described with reference to apparatus diagrams, system diagrams, and flowcharts that relate to OTA aggregation federated learning with non-connected devices.

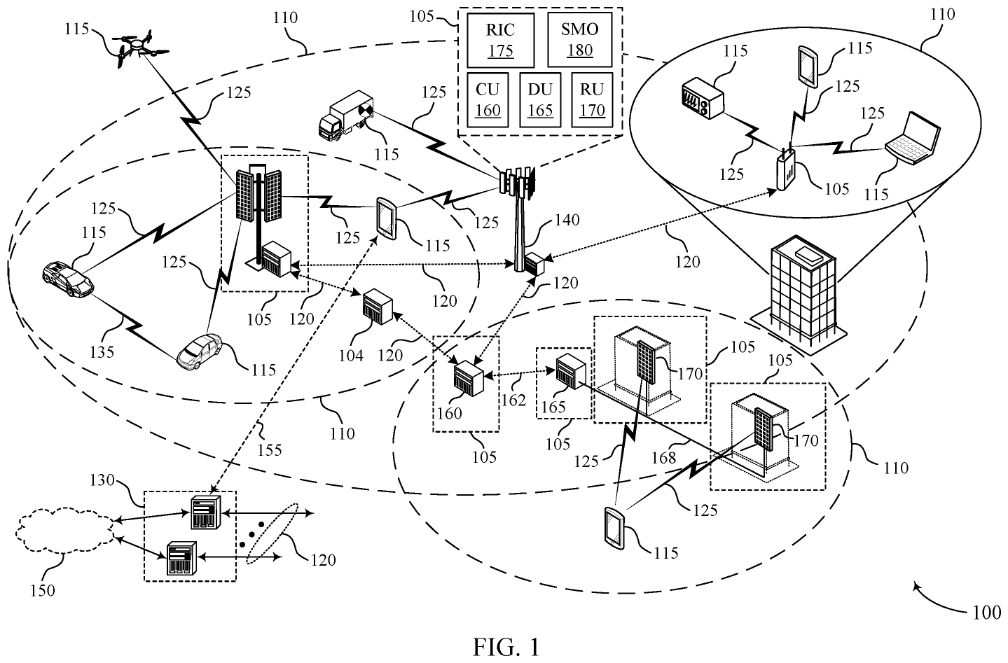

FIG. 1 illustrates an example of a wireless communications system 100 that supports OTA aggregation federated learning with non-connected devices in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., RRC, service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support OTA aggregation federated learning with non-connected devices as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Aƒₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrow band IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrow band communications), or a combination of these techniques. For example, some UEs 115 may be configured for operation using a narrow band protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

Some wireless communications systems may implement federated learning to train a machine learning model. Federated learning my train a machine learning model, such as a global machine learning model, in a distributed model. With federated learning, one or more clients (e.g., UEs 115 or other devices) may employ a same machine learning model or machine learning model structure. The machine learning model, or machine learning model structure, may be associated with a common task associated with, or performed by, the UEs 115. The UEs 115 may independently or locally train model parameters of the machine learning model based on respective observations or data collection.

UEs 115 participating in or performing federated learning may periodically send information for the updated model parameters to a server. The server may be an example of a network entity 105 or its components described herein. In some examples, a UE 115 may be an example of the server, or a UE 115 may perform techniques of a server. The server may compile information from the UEs 115 to generate global, or aggregated, model parameters. In some examples, this may be referred to as updating the machine learning model, where the information reported from the UEs 115 is used to train the machine learning model at the server and generate an updated version of the machine learning model using the gathered data. The server may send or forward the updated model parameters, and the UEs 115 may update the local machine learning models with the updated model parameters. For example, the server may transmit an indication of the updated machine learning model to the UEs 115. In some cases, the server may send the updated machine learning model to UEs 115 participating in the federated learning procedure or to UEs 115 not participating in the federated learning procedure, or both.

In some examples, the server may implement a stochastic gradient descent (SGD) model training. For example, at iteration or epoch i, the server may update the global model parameters according to Equation (1), where θⁱ is a vector of the model parameters at iteration i, gₙⁱ is the gradient vector computed by the n-th UE 115 at iteration i, N_{UEs} is a quantity of UEs 115 participating in the ith round, and ηⁱ is a learning rate applied by the server. In some examples, Equation (1) may be applied if each UE 115 performs a local update using a same amount of training data. In some examples, local training may be performed over data unevenly distributed (e.g., in quantity) among UEs 115, in which case the server may compute a weighted sum (e.g., instead of an average) of the gradient values.

$${θ}^{i} = {θ}^{i - 1} - {η}^{i} {\sum }_{n = 1}^{{N}_{UEs}} {g}_{n}^{i} \qquad ( 1 )$$

Machine learning models may have many parameters, such as tens of thousands or hundreds of thousands of parameters. If UEs 115 were to transmit gradients of model parameters on uplink shared channel resources or uplink control channel resources, a payload of transmission of the gradients may incur very large overhead when there is a large quantity of UEs 115 participating in the federated learning procedure.

To reduce overhead, some systems may perform OTA aggregation (e.g., OTA analog aggregation). Each gradient for the model parameters is mapped to a single resource (e.g., a single resource element), and each UE 115 transmits a computed analog gradient value over the resource. For example, each UE 115 may determine gradients for the model parameters, and each UE 115 may transmit a computed analog gradient for a model parameter on a same resource. A receiver (e.g., the server) may observe the superposition of the transmitted gradient values. The superposition of the transmitted gradient values may provide an indication of an average, or a sum, of the gradient values from each of the UEs 115 participating in the federated learning procedure. As such, the server may obtain the gradients for the model parameters using significantly fewer resources than each UE 115 reporting gradients on respective sets of resources.

Federated learning with OTA analog aggregation may improve scalability for a large quantity of UEs 115 contributing to the federated learning session by using the superposition property of the wireless medium. UEs 115 transmitting in accordance with OTA aggregation may be configured with power control instructions, as the contributions of the UEs 115 may need to be received with a same power, or approximately the same power, to avoid near-far effects if the values transmitted by the UEs 115 are first normalized. Near-far effects may render the received aggregated signal as more representative of UEs 115 experiencing smaller path loss than other, such as based on distance, channel quality, or line-of-sight conditions. UEs 115 experiencing small path loss (e.g., UEs 115 near the server) may reduce a transmit power compared to UEs 115 with high path loss (e.g., UEs 115 farther away from the server). By implanting this power control, the gradients may be received at the server with a same average power. In some examples, each UE 115 may be configured with a same nominal transmit power to ensure the gradients are received at the server with a same average power.

For uplink power control, an uplink shared channel transmit power for transmission type j may be provided by Equation (2) below. In Equation (2), P_{CMAX,f,c}(i) may be preconfigured maximum UE transmit power for PUSCH transmission on BWP b over carrier f and cell c for transmission occasion i. P_{O-PUSCH,b,f,c}(j) may be a nominal UE transmit power per resource block with 15 kHz SCS for transmission type j, which may be a value computed based on a cell-specific nominal power value (e.g., provided via system information or RRC signaling) and, in some cases, a UE-specific offset (e.g., provided via RRC signaling). M_{RB,b,f,c}^{PUSCH}(j) may be a quantity of allocated resource blocks for transmission type j. α_{b,f,c} may be fractional power control parameter, PL_{b,f,c}(q_{d}) may be a link path loss measured using a reference signal with identifier q_{d}, Δ_{TF,b,vc}(i) may be an MCS-dependent offset, and f_{b,f,c}(i, l) may be a closed loop power control component corresponding to power control adjustment state l. In some examples, when f_{b,f,c}(i, l)=0, power control may be open loop (e.g., implemented without network entity 105 assistance).

$${P}_{PUSCH , b , f , c} ( i , j , {q}_{d} , l ) = min \{ \begin{matrix}{P}_{CMAX , f , c} ( i ) , \\ {P}_{{O}_{PUSCH , b , f , c} ( j ) + 10 {log}_{10} ( {2}^{μ} \cdot {M}_{RB , b , f , c}^{PUSCH} ( i ) ) + {α}_{b , f , c} ( j ) \cdot {PL}_{b , f , c} ( {q}_{d} ) + {Δ}_{TF , b , f , c} ( i ) + {f}_{b , f , c} ( i , l )}\end{matrix} \} \qquad ( 2 )$$

Sidelink power control may be similar to uplink power control. However, sidelink power control may be open loop instead of either open loop or closed loop. In some examples, sidelink power control may consider downlink pathloss (e.g., if the transmitting UE 115 is under network coverage) and sidelink pathloss.

When each UE 115 contributing to a federated learning session is in an RRC connected state (e.g., via uplink to a network entity 105 or via sidelink to another UE 115 or roadside unit), the current power control framework may be implemented. The server (e.g., a network entity 105, UE 115, or roadside unit) may provide explicit instructions to each UE 115 by configuring nominal received power for open loop power control and, in some cases, additional closed loop adaptation commands.

The wireless communications system 100 may support non-connected UEs 115 to participate in, or perform, federated learning using OTA aggregation. For federated learning over uplink, since federated learning updates are independent of other communication activity, a UE 115 not in RRC connected mode may still participate in a federated learning training round. For federated learning over sidelink, mobility of UEs 115 may result in significant overhead to establish and release RRC connections. Therefore, federated learning with non-RRC connected UEs 115 may be similarly efficient. For example, if a fixed-position RSU is the server that receives contributions from vehicles passing by, there may be a large overhead to establish and keep track of RRC connections with UEs 115 contributing to each training round. With non-coherent OTA federated learning schemes, the tight timing, phase, and frequency requirements of coherent OTA federated learning (e.g., satisfied via RRC connected mode), are not required. However, these techniques may similarly be implemented for coherent OTA federated learning.

In some examples, a UE 115 that participates in a federated learning training round may transmit gradient values to the server. In some cases, the UE 115 may normalize the gradient values and transmit the normalized gradient values to the server. UEs 115 may, in some cases, still collect data, train the machine learning model to obtain model parameters, and receive updates of the global machine learning model even if not participating (e.g., transmitting the gradient values) in a training round or the federated learning procedure. In some cases, participating in a federated learning training round may be referred to as performing a federated learning procedure.

For example, the wireless communications system 100 may implement a procedure that invites or requests non-connected UEs 115 to participate in a federated learning training round. This procedure may align the UEs 115 to operate on a same model and apply a same federated learning aggregation scheme.

The wireless communications system 100 may also support power control techniques to support non-RRC connected UEs 115 to participate in the OTA federated learning procedure. In some examples, the server may not be aware of path loss conditions experienced by contributing UEs 115 to determine a target receive power (e.g., a nominal transmit power) for the participating UEs 115. Additionally, or alternatively, the server may not be aware of a quantity of UEs 115 participating in a federated learning training round. For example, contributing to a federated learning training round while not in RRC connected mode may be optional for UEs 115, and UEs 115 not in RRC connected mode may participate without explicitly announcing so. If the server or server receiver has a limited dynamic range, the aggregated power may overwhelm the server if there is a very high quantity of UEs 115 participating. The power control techniques described herein may enable non-RRC connected UEs 115 to determine whether to participate or determine a transmit power for participating to avoid power control complications at the server. For example, the wireless communications system 100 may support a power control mechanism which allows non-RRC connected UEs 115 to participate in a federated learning training round, adapts to changing path loss conditions, and adapts to a changing quantity of UEs 115 between training rounds.

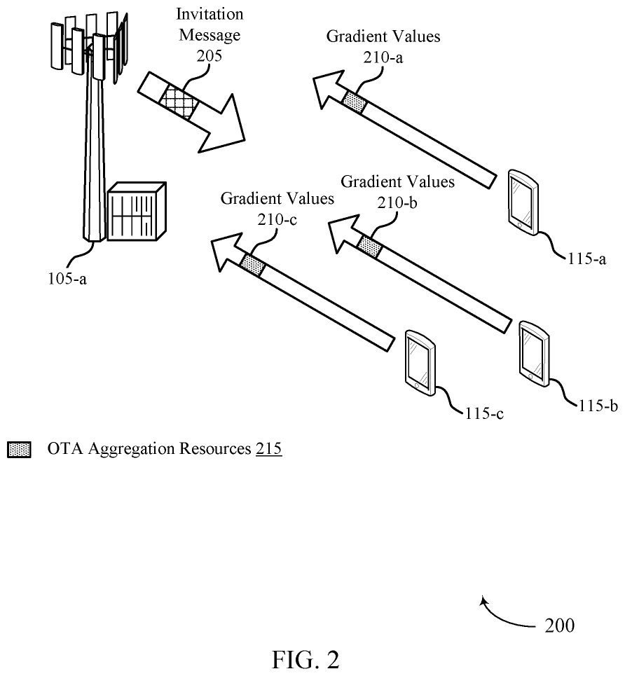

FIG. 2 illustrates an example of a wireless communications system 200 that supports OTA aggregation federated learning with non-connected devices in accordance with one or more aspects of the present disclosure. The wireless communications system 200 may include UE 115-a, UE 115-b, and UE 115-c, each of which may be an example of a UE 115 as described with reference to FIG. 1. The wireless communications system 200 may include network entity 105-a, which may be example of a network entity as described with reference to FIG. 1. In some examples, the network entity 105-a may be an example of a server for a federated learning procedure as described herein. Additionally, or alternatively, a UE 115 may be an example of the server.

The wireless communications system 200 may support a federated learning procedure to train a machine learning model. For a federated learning procedure, multiple clients, the UEs 115, may employ a same machine learning model structure to locally train model parameters for the machine learning model based on observations or data. The UEs 115 may send information for updated model parameters to a server, such as the network entity 105-a, which compiles the information from all of the UEs 115 to determine global or aggregated model parameters. The network entity 105-a may then send the updated model parameters, or an updated machine learning model, to the clients. The federated learning procedure may include multiple training rounds, each of which may be dynamically scheduled by the network entity 105-a. The network entity 105-a may receive the information for the model parameters, update the machine learning model, and transmit information for an updated version of the machine learning model to the clients for another round of the federated learning procedure.

The wireless communications system 200 may use OTA aggregation techniques to reduce overhead for UEs 115 reporting information for the updated, or locally-trained, model parameters. A machine learning model may have a large quantity of parameters (e.g., tens or hundreds of thousands of parameters), and each UE 115 individually reporting the machine learning model parameters may have significant overhead. To reduce the overhead, the UEs 115 may transmit gradients for the locally-trained model parameters on a same set of resources, such as OTA aggregation resources 215. For example, each gradient may be mapped to a respective resource element, and each UE 115 may transmit gradient values 210 over the OTA aggregation resources 215. In an example, the UE 115-a may transmit gradient values 210-a, UE 115-b may transmit gradient values 210-b, and the UE 115-c may transmit gradient values 210-c on the OTA aggregation resources 215.

A receiver, such as the network entity 105-a or a UE 115 acting as the server, may observe the superposition of the gradient values 210. In some examples, the superposition of the gradient values 210 may correspond to averages of the gradient values for the model parameters. The network entity 105-a may determine average values for the model parameters from all clients (e.g., UEs 115) participating in the federated learning procedure and use the average values for the model parameters to train and update the machine learning model.

Techniques described herein support a federated learning procedure for non-connected UEs 115 using OTA aggregation. These techniques may enable non-connected UEs 115, such as UEs 115 operating in an RRC idle or RRC inactive state, to participate in one or more training rounds for federated learning using OTA aggregation without switching to an RRC connected mode. For example, the UE 115-a may be an example of a UE 115 operating in a non-connected state, such as an RRC inactive or RRC idle state. These techniques may include power control procedures for non-connected UEs 115 to transmit gradient values 210 on the OTA aggregation resources 215 such that the gradient values 210 are received with a same power at the network entity 105-a

The network entity 105-a may transmit an invitation message 205 prior to a federated learning training round to invite (e.g., request) for UEs 115 to participate in an upcoming training round for the federated learning procedure. The invitation message 205 may invite, or request, UEs 115 to participate in the upcoming round of the federated learning procedure. The invitation message 205 may invite both UEs 115 in a connected mode (e.g., RRC connected) and non-connected mode (e.g., RRC inactive or RRC idle). In some examples, such as for uplink federated learning, the invitation message 205 may be transmitted via downlink control information. For example, the invitation message may be referred to as an invitation downlink control information or control signal that requests for a UE 115 to perform a federated learning procedure. In some cases, the invitation message 205 may be transmitted during a paging occasion or a paging frame. In some examples, the invitation message 205 may be used to broadcast global updates for a machine learning model. Additionally, or alternatively, the server may separately broadcast global updates or versions for the machine learning model (e.g., to participating UEs 115 or non-participating UEs 115).

The invitation message 205 may indicate a configuration, or a set of parameters, for the federated learning procedure. For example, the invitation message may indicate a machine learning model, an OTA aggregation scheme, resources for OTA aggregation, and the like. For example, a UE 115 participating in the federated learning procedure may update the local model starting from the global model based on an outcome (e.g., an update) from a previous training round. For example, the network entity 105-a may broadcast an initial, global machine learning model and updates (e.g., updated parameters) for the machine learning model based on previous training rounds.

To avoid mismatches where a UE 115 participates or joins in a training round but uses a different or outdated version of the machine learning model, the invitation message 205 may indicate the machine learning model that is used in the next training round. In some cases, the invitation message 205 may indicate a machine learning model from a set of machine learning models. For example, the UEs 115 may be configured (e.g., pre-configured via RRC) the set of machine learning models, and an identifier in the invitation message 205 may indicate a machine learning model to use from the set of machine learning models. In some cases, the invitation message 205 may include a pointer to an entry of a table (e.g., a look-up table) configured at the UEs 115.

Additionally, or alternatively, the invitation message 205 may explicitly indicate a model structure for the machine learning model. For example, the invitation message 205 may indicate a quantity of layers, a size of each layer, an ordering of the layers, or a connectivity of the layers, or any combination thereof, for the machine learning model.

In some examples, the invitation message 205 may indicate a version of the machine learning model. For example, when the network entity 105-a updates the global model and broadcasts a message of the outcome (e.g., the updated machine learning model), the network entity 105-a may include a version identifier with the broadcasted message. In some examples, the invitation message 205 may include a version identifier of the latest broadcasted model update. A UE 115 whose last received version identifier does not match the latest version model identifier may not participate in an upcoming training round. The UE 115 may receive the latest version in a following broadcast message and participate after receiving the current version of the updated machine learning model.

In some examples, the invitation message 205 may indicate a federated learning scheme for the federated learning procedure. In some examples, the invitation message 205 may indicate an OTA aggregation scheme. For example, the invitation message 205 may indicate resources over which the UE updates are transmitted over. For example, the invitation message 205 may indicate the OTA aggregation resources 215. In some examples, the federated learning scheme may be indicated from a set of federated learning schemes (e.g., preconfigured via RRC signaling). In some examples, the OTA aggregation scheme may be indicated from a set of OTA aggregation schemes (e.g., preconfigured via RRC signaling).

In some examples, the invitation message may indicate power control instructions for reporting gradient values for model parameters. Indicating the power control instructions may enable non-RRC connected UEs 115 to report the gradient values such that the gradient values are received with a same power as other UEs 115 participating in the federated learning procedure. The server may not be aware of path losses of the non-RRC connected mode UEs 115 participating in the federated learning procedure to provide a power control recommendation.

In some examples, UEs 115 within a certain range of the network entity 105-a may participate in the federated learning procedure. For example, the network entity 105-a may identify where the furthest contributing UEs 115 are located and what the received power from the furthest contributing UEs 115 would be if transmitting with full power. In some cases, the network entity 105-a may determine a received power of worst-case UEs 115 (e.g., UEs 115 at a furthest distance from the network entity 105-a that can still participate in the federated learning procedure). In some cases, the network entity 105-a may then determine a nominal transmit power for UEs 115 participating in the federated learning procedure.

For example, the invitation message 205 may indicate a distance (e.g., a maximum distance) from the network entity 105-a, and UEs 115 within the distance from the network entity 105-a may participate in the federated learning procedure or a next round of the federated learning procedure. In some cases, the network entity 105-a may indicate a large distance to enable a large quantity of UEs 115 to participate. In some examples, the network entity 105-a may indicate a short distance to avoid limiting power due to a worst-case UE 115 (e.g., a UE 115 which would contribute with very low transmit power).

In some examples, the invitation message 205 may indicate a reference signal and a power threshold. In some cases, an RSRP threshold may be an example of the power threshold. UEs 115 which measure an RSRP of the reference signal that is above the RSRP threshold may participate in the federated learning procedure or a next training round of the federated learning procedure. For example, the UE 115-a may measure a reference signal indicated by the invitation message 205. The UE 115-a may compare an RSRP measurement of the reference signal to the RSRP threshold indicated by the invitation message 205. If the RSRP measurement of the reference signal satisfies (e.g., exceeds) the RSRP threshold indicated by the invitation message, the UE 115-a may participate in the federated learning procedure.

In some examples, the invitation message 205 may indicate a nominal UE transmit power. For example, the invitation message 205 may indicate a nominal UE transmit power for the participating UEs 115 to apply when transmitting the gradient values 210. In some cases, the nominal UE transmit power indicated by the invitation message 205 may be used for OTA federated learning procedures but not conventional transmissions (e.g., other PUSCH or PUCCH transmissions).

In some examples, a federated learning procedure with non-RRC connected UEs 115 or a federated learning procedure in mode 2 sidelink operation may use open loop power control. In some cases, for open loop power control, the UEs 115 may use a path loss estimate with the indicated nominal UE transmit power. In some cases, the invitation message 205 may indicate a path-loss reference signal. A participating UE 115 may measure the path-loss reference signal (e.g., a higher-layer filtered RSRP of the path-loss reference signal) and subtract the measurement from a reference signal power value indicated by higher layer signaling. For example, the UE 115-a may measure the indicated path-loss reference signal to obtain an RSRP of the path-loss reference signal. The UE 115-a may compare the RSRP of the path-loss reference signal to a reference signal power indicated via RRC signaling to obtain a path loss estimate to the network entity 105-a. The UE 115-a may use the nominal UE transmit power and the path loss estimate to determine a transmit power for transmitting the gradient values 210-a on the OTA aggregation resources 215.

In another example, the network entity 105-a may indicate a location of the network entity 105, and the UEs 115 may use the location of the network entity 105-a to estimate path loss. For example, the UE 115-a may receive the invitation message 205 indicating the location of the network entity 105-a. The UE 115-a may know its own location (e.g., the location of the UE 115-a), and the UE 115-a may compute a distance between the network entity 105-a and the UE 115-a to estimate a path loss from the UE 115-a to the network entity 105-a. In some examples, the UE 115-a may use a path loss model to estimate the path loss. In some examples, the path loss model may be preconfigured (e.g., via RRC signaling). In some cases, the path loss model may be indicated via the invitation message 205. For example, the invitation message may include a pointer or identifier to the path loss model from a table of path loss models or path loss model parameters. In some examples, the path loss estimation may be different for different UEs 115, or up to UE implementation.

In some examples, non-RRC connected UEs 115 participating in federated learning procedures over uplink may operate in a discontinuous reception (DRX) mode. The invitation message 205 may include aspects of a wakeup signal or paging signal for the non-connected UEs 115 to participate in a federated learning training round. In some cases, the UEs 115 may be configured with paging frames or paging occasions associated with the invitation message 205. For example, paging frames and occasions used to monitor for the invitation message 205 may be configured at the UEs 115. In some examples, the paging frames and occasions associated with the invitation message 205 may not overlap with paging frames and occasions for conventional DRX or non-invitation message signaling.

In some cases, the invitation message 205 may be transmitted to UEs 115 that are interested in participating in the federated learning procedure. Therefore, the invitation message 205 may not be transmitted to UEs 115 that are not interested in the federated learning procedure or that do not want to participate in the federated learning procedure. In some cases, the network entity 105-a may transmit a wakeup signal for the invitation message 205 which is broadcasted prior to the invitation message 205. UEs 115 that are interested in receiving the invitation message 205 may wake up (e.g., enter a DRX on mode) to monitor for and receive the invitation message 205. Additionally, or alternatively, the invitation message 205 may be transmitted using a paging radio network temporary identifier (P-RNTI), and the P-RNTI may include an additional field indicating that the invitation message 205 is associated with the federated learning procedure. For example, the invitation message 205 may include an additional field indicating that the invitation message is to initiate a federated learning training round. UEs which do not want to participate in the training round can avoid decoding associated PDSCH. In some examples, the invitation message 205 may be transmitted using an RNTI that is specific to, or dedicated for, the federated learning procedure. UEs 115 that would participate in the federated learning procedure may receive the invitation message 205 by decoding the invitation message 205 using the dedicated RNTI.

In some cases, some paging frames or occasions may be associated with the invitation message 205. For example, the invitation message 205 may be transmitted during paging frames or paging occasions that are associated with the federated learning procedure. These paging frames or paging occasions may not overlap with paging frames and paging occasions associated with other types of signaling (e.g., non-federated learning signaling).

When the federated learning procedure is performed over a sidelink channel (e.g., a UE 115 is the server), the invitation message 205 may be transmitted as different types of signaling. For example, the invitation message 205 may be transmitted as a broadcast transmission with sidelink control information indicating the signaling carrying the invitation message 205 is an invitation for a federated learning procedure. In another example, the invitation message 205 may be transmitted via a groupcast transmission with sidelink control information indicating the signaling carrying the invitation message 205 is an invitation for a federated learning procedure. In some cases, the invitation message 205 may be transmitted as either a groupcast transmission or a broadcast transmission, and a payload of the invitation message 205 may indicate that the signaling is an invitation for the federated learning procedure.

In some examples, the invitation message 205 may include conditions for a UE 115 to participate in a next training round. For example, the UE 115-a may receive the invitation message 205 and determine whether to join the next training round for the federated learning procedure based on whether the UE 115-a satisfies the conditions. If the UE 115-a satisfies the conditions, the UE 115-a may join the training round. If UE 115-a does not satisfy the conditions, the UE 115-a may not join the training round. For example, the invitation message 205 may indicate a condition that participating UEs 115 have a latest version identifier for the machine learning model, have a minimum local dataset size, have a recently acquired dataset, or any combination thereof. In some examples, a recently acquired dataset may be a dataset acquired no earlier than an indication threshold of time or no earlier than an indicated time.

In some cases, restricting the distance of UEs 115 participating in the federated learning procedure may provide the server (e.g., the network entity 105-a) with information of path loss experienced by participating UEs 115. The network entity 105-a may then set a nominal UE transmit power in the invitation message 205 using an estimate of how many UEs 115 (e.g., on average) are participating. The estimate may be based on an estimate of density of UEs 115 in the area, such as an area served by the network entity 105-a. However, with UEs 115 being supported to participate without formally announcing or indicating participation, a quantity of UEs 115 participating may be so high as to increase the aggregated received power beyond a receiver dynamic range. The wireless communications system 200 may support techniques to reduce the aggregated received power in following training rounds.

For example, when the server identifies an aggregation round failure due to excessive received power, the server may not update the global model of the machine learning model, and the server may not broadcast a global model update. For a next training round, the server may transmit the invitation message 205 pointing to the same model version identifier as in the previous invitation message. However, the invitation message 205 for the next training round may indicate a reduced nominal UE transmit power (e.g., compared to previous rounds). When a UE 115 receives an invitation message 205 with a same version as a previous invitation message, the UE 115 may not perform any local updates to the local machine learning model. The UE 115 may transmit a same signal as the previous round but in accordance with the updated power control configuration (e.g., the reduced nominal UE transmit power). In some examples, if the UE 115 obtained additional data samples between the two rounds, the UE 115 may retrain the local model using the expanded data set or refrain from training the local model until the global model is updated.

In another example, when the server identifies an aggregation round failure due to excessive received power, the server may indicate a probability (e.g., a scalar value) between 0 and 1. A UE 115 may participate in the next round with the probability indicated. For example, the UE 115 may determine a random value between 0 and 1, and if the determined random value exceeds the indicated scalar value, the UE 115 may participate in the next training round. These techniques may reduce a quantity of UEs participating in the next round without reducing UE transmit power.

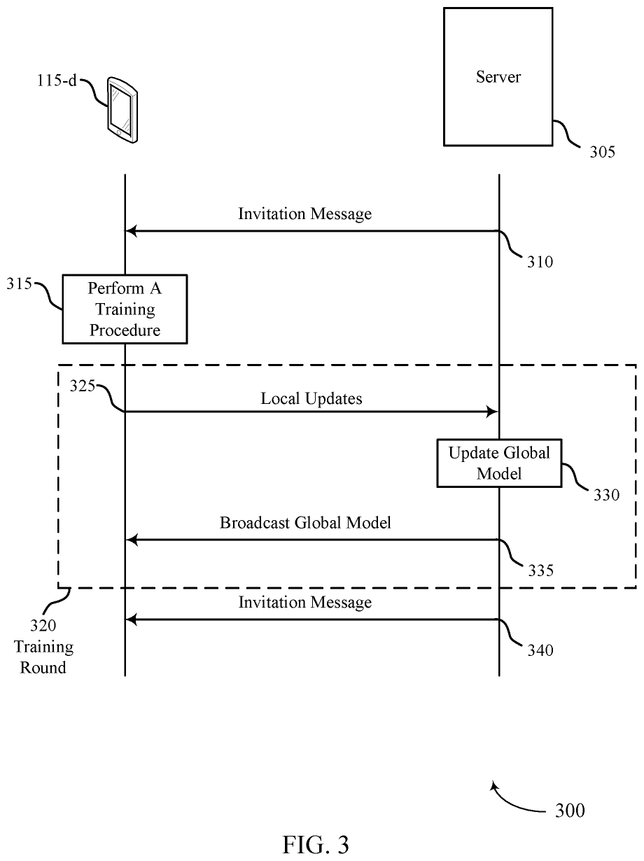

FIG. 3 illustrates an example of a process flow 300 that supports OTA aggregation federated learning with non-connected devices in accordance with one or more aspects of the present disclosure. The process flow 300 may be performed by one or more UEs 115, such as a UE 115-d, or a server 305, or any combination thereof. The server 305 may be an example of a UE 115 or a network entity 105 as described with reference to FIGS. 1 and 2. The UE 115-d may be an example of a UE 115 as described with reference to FIGS. 1 and 2. In some examples, some additional processes or signaling not shown by FIG. 3 may occur. Additionally, or alternatively, some processes or signaling shown by the FIG. 3 may not occur. In some examples, some processes or signaling of the process flow 300 may occur in a different order than shown.

At 310, the server 305 may transmit, and the UE 115-d may receive, a first message requesting the UE 115-d to perform a federated learning procedure. The first message may indicate a machine learning model and a configuration for the federated learning procedure. For example, the server 305 may transmit an invitation message to the UE 115-d, which may invite or request for the UE 115-d to participate in a training round 320 for federated learning (e.g., transmit local updates for the machine learning model). In some examples, the server 305 may transmit an indication of a global machine learning model, which may be indicated via the first message or indicated via a separate transmission.

At 315, the UE 115-d may perform, in response to the first message requesting the UE to perform the federated learning procedure, a training procedure using the machine learning model to obtain one or more model parameters based on the configuration for the federated learning procedure. For example, the UE 115-d may locally train the machine learning model using a dataset collected by the UE 115-d. The UE 115-d may determine updates for parameters of the machine learning model based on training the machine learning model using the dataset. In some examples, the UE 115-d may locally train the machine learning model regardless of whether the UE 115-d is participating in the training round 320 for federated learning.

In some cases, the UE 115-d may determine whether to perform the federated learning procedure based on the first message. For example, the UE 115-d may determine whether the UE 115-d satisfies conditions to perform the federated learning procedure or participate in a next round for the federated learning. In some cases, the first message may indicate a version for the machine learning model. The UE 115-d may determine that a version of the machine learning model at the UE 115-d matches the version indicated by the first message, such that the UE 115-d has a latest version of the machine learning model. The UE 115-d may be able to participate in the training round 320 based on having the latest version of the machine learning model. In some examples, criteria for participating in the training round 320 may be based on a version for the machine learning model, a local dataset size (e.g., a minimum local dataset size), an acquisition time for a local dataset at the UE, or any combination thereof.

In some examples, the first message may indicate a range associated with participating in the federated learning procedure. For example, the invitation message may indicate a maximum distance from the server 305 for UEs 115 to participate in the training round. The UE 115-d may determine whether the UE 115-d is within the range, and the UE 115-d may participate in the training round 320 for the federated learning procedure based on being within the range.

In some examples, the first message may indicate a reference signal and a threshold. For example, the threshold may be an RSRP threshold. The UE 115-d may measure the indicated reference signal to obtain a measurement of the reference signal and compare the measurement to the threshold. If the measurement satisfies the threshold (e.g., exceeds the RSRP threshold), the UE 115-d may participate in the training round 320.

In some examples, the first message may indicate the machine learning model from a set of machine learning models (e.g., a set of one or more machine learning models). For example, the UE 115-d may be configured (e.g., via RRC signaling) with the set of machine learning models. In some examples, the first message may include a pointer to the machine learning model in a table of machine learning models. Additionally, or alternatively, the first message may indicate a version of the machine learning model from a set of versions of the machine learning model. Additionally, or alternatively, the first message may indicate an OTA aggregation scheme from a set of OTA aggregation schemes or a federated learning scheme from a set of federated learning schemes, or both.

In some examples, the UE 115-d may determine to participate in the training round 320. At 325, the UE 115-d may transmit a second message indicating one or more gradient values for the one or more model parameters via one or more resources configured for OTA aggregation based on the configuration for the federated learning procedure. For example, multiple UEs 115 may participate in the training round 320, and each UE 115 may report gradient values for the machine learning model parameters by transmitting analog gradient values of the machine learning model parameters on a same set of resources. The server 305 may observe the superposition of the analog gradient values to determine a set of parameters for training the machine learning model.

The UE 115-d may perform power control techniques to transmit the second message indicating the one or more gradient values. In some cases, the power control techniques may ensure the signals from the participating UEs 115 are received with a same power at the server 305.

In some examples, the first message may indicate a nominal transmit power for transmitting the second message on the one or more resources configured for the OTA aggregation. In some examples, the UE 115-d may transmit the second message based on the nominal transmit power.

For example, the UE 115-d may receive an indication of a path loss reference signal and an indication of a reference signal power value. The indication of the path loss reference signal or the indication of the reference signal power value, or both, may be indicated via the first message or via other signaling (e.g., RRC signaling), or both. The UE 115-d may measure the path loss reference signal and compare a measurement of the path loss reference signal to the reference signal power value (e.g., subtracting the measurement value from the reference signal power value). The UE 115-d may determine a path loss to the server 305 based on the comparison of the path loss reference signal to the reference signal power value. The UE 115-d may transmit the second message using a transmit power that is based on the path loss to the server 305 and the nominal transmit power indicated by the first message.

In another example, the UE 115-d may receive an indication of a location of the server 305. The UE 115-d may determine a path loss estimate for the second message based on a distance between the UE 115-d and the location of the server 305 and a path loss model. The UE 115-d may transmit the second message based on the path loss estimate and the nominal transmit power indicated by the first message.

The server 305 may receive multiple second messages from multiple UEs 115 on the one or more resources configured for OTA aggregation. The multiple second messages may indicate multiple sets of gradient values for the machine learning model parameters. At 330, the server 305 may train the machine learning model using the multiple sets of one or more model parameters. For example, the server 305 may update the global machine learning model based on the reported gradient values from the participating UEs 115.

In some cases, the server 305 may broadcast an updated global model for the machine learning model at 335. For example, after updating the machine learning model based on the gradient values from the participating UEs 115, the server 305 may broadcast or transmit the updated machine learning model. The updated machine learning model may be used by participating UEs 115 for a next federated learning training round. In some examples, at 340, the server 305 may transmit another invitation message for the next federated learning training round.

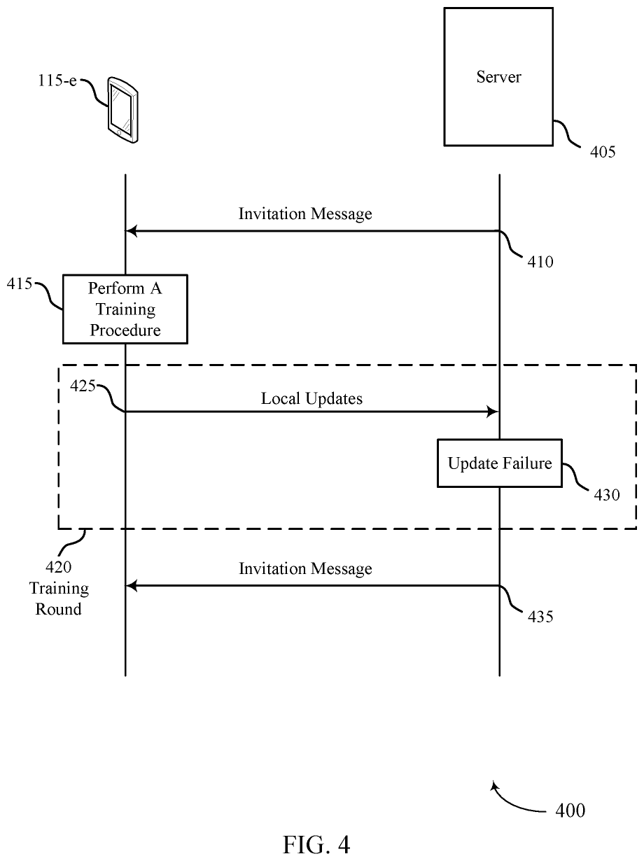

FIG. 4 illustrates an example of a process flow 400 that supports OTA aggregation federated learning with non-connected devices in accordance with one or more aspects of the present disclosure. The process flow 400 may be performed by one or more UEs 115, such as a UE 115-e, or a server 405, or any combination thereof. The server 405 may be an example of a UE 115 or a network entity 105 as described with reference to FIGS. 1 and 2. The UE 115-e may be an example of a UE 115 as described with reference to FIGS. 1 and 2. In some examples, some additional processes or signaling not shown by FIG. 4 may occur. Additionally, or alternatively, some processes or signaling shown by the FIG. 4 may not occur. In some examples, some processes or signaling of the process flow 400 may occur in a different order than shown.

At 410, the server 405 may transmit, and the UE 115-e may receive, a first message requesting the UE 115-e to perform a federated learning procedure. The first message may indicate a machine learning model and a configuration for the federated learning procedure. For example, the server 405 may transmit an invitation message to the UE 115-e, which may invite or request for the UE 115-e to participate in a training round 420 for federated learning (e.g., transmit local updates for the machine learning model). In some examples, the server 405 may transmit an indication of a global machine learning model, which may be indicated via the first message or indicated via a separate transmission.

At 415, the UE 115-e may perform, in response to the first message requesting the UE 115-e to perform the federated learning procedure, a training procedure using the machine learning model to obtain one or more model parameters based on the configuration for the federated learning procedure. For example, the UE 115-e may locally train the machine learning model using a dataset collected by the UE 115-e. The UE 115-e may determine updates for parameters of the machine learning model based on training the machine learning model using the dataset. In some cases, the UE 115-e may determine whether to perform the federated learning procedure based on the first message. In some examples, criteria for participating in the training round 420 may be based on a version for the machine learning model, a local dataset size (e.g., a minimum local dataset size), an acquisition time for a local dataset at the UE, or any combination thereof.

In some examples, the UE 115-e may determine to participate in the training round 420. At 425, the UE 115-e may transmit a second message indicating one or more gradient values for the one or more model parameters via one or more resources configured for OTA aggregation based on the configuration for the federated learning procedure. For example, multiple UEs 115 may participate in the training round 420, and each UE 115 may report gradient values for the machine learning model parameters by transmitting analog gradient values of the machine learning model parameters on a same set of resources. The server 405 may observe the superposition of the analog gradient values to determine a set of parameters for training the machine learning model.

The server 405 may receive multiple second messages from multiple UEs 115 on the one or more resources configured for OTA aggregation. However, in some cases, the received power of the signaling may be excessive such that the aggregated received power exceeds a receiver dynamic range. This may cause an aggregation failure, and the server 405 may be unable to update the global model. For example, the server 405 may determine a training of the machine learning model using sets of model parameters is unsuccessful based on an excessive received power of the multiple second messages at 430.

At 435, the server 305 may transmit a second invitation message requesting for the multiple UEs 115 to perform the federated learning procedure, where the second invitation message indicates the same machine learning model version as the previous training round and a reduced nominal UE transmit power. By indicating the reduced nominal UE transmit power, the gradient values in the next training round may be transmitted with a reduced transmit power, which may prevent aggregation failure.

In some examples, the UE 115-e may identify the second invitation message with the same model version as the previous training round. In some cases, the UE 115-e may refrain from performing local updates for the machine learning model. The UE 115-e may transmit the gradient values on the next set of OTA aggregation resources based on the reduced nominal UE transmit power.

In some other examples, when the server 405 identifies an aggregation round failure due to excessive received power, the server 405 may indicate a probability (e.g., a scalar value) between 0 and 1 in the invitation message. UEs 115 may participate in the next round with the probability indicated. For example, the UE 115-e may determine a random value between 0 and 1, and if the determined random value exceeds the indicated scalar value, the UE 115-e may participate in the next training round. These techniques may reduce a quantity of UEs 115 participating in the next round without reducing UE transmit power.

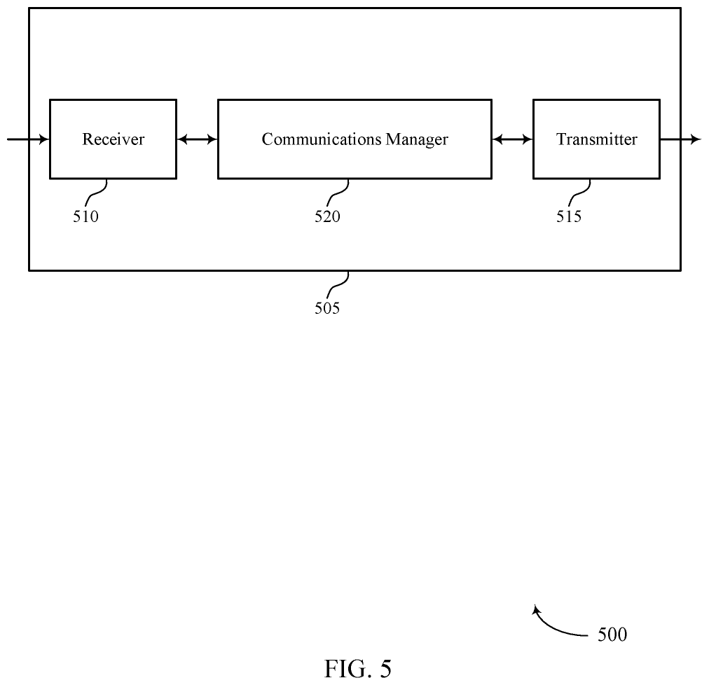

FIG. 5 shows a block diagram 500 of a device 505 that supports OTA aggregation federated learning with non-connected devices in accordance with one or more aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to OTA aggregation federated learning with non-connected devices). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to OTA aggregation federated learning with non-connected devices). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of OTA aggregation federated learning with non-connected devices as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications at a UE in accordance with examples as disclosed herein. For example, the communications manager 520 may be configured as or otherwise support a means for receiving a first message requesting the UE to perform a federated learning procedure, the first message indicating a machine learning model and a configuration for the federated learning procedure. The communications manager 520 may be configured as or otherwise support a means for performing, in response to the first message requesting the UE to perform the federated learning procedure, a training procedure using the machine learning model to obtain one or more model parameters based on the configuration for the federated learning procedure. The communications manager 520 may be configured as or otherwise support a means for transmitting a second message indicating one or more gradient values for the one or more model parameters via one or more resources configured for OTA aggregation based on the configuration for the federated learning procedure.

Additionally, or alternatively, the communications manager 520 may support wireless communications at a wireless device in accordance with examples as disclosed herein. For example, the communications manager 520 may be configured as or otherwise support a means for transmitting a first message requesting a set of multiple UEs to perform a federated learning procedure, the first message indicating a machine learning model and a configuration for the federated learning procedure. The communications manager 520 may be configured as or otherwise support a means for receiving a set of multiple second messages indicating a set of multiple sets of gradient values for a set of multiple sets of one or more model parameters via one or more resources configured for OTA aggregation based on the configuration for the federated learning procedure. The communications manager 520 may be configured as or otherwise support a means for training the machine learning model using the set of multiple sets of one or more model parameters.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for more efficient utilization of communication resources by using OTA aggregation for federated learning with non-connected UEs 115. By increasing a quantity of UEs 115 participating in federated learning, these techniques provide a greater reduction of resource overhead and utilization by enabling the non-connected UEs 115 to perform OTA aggregation with efficient power control techniques.

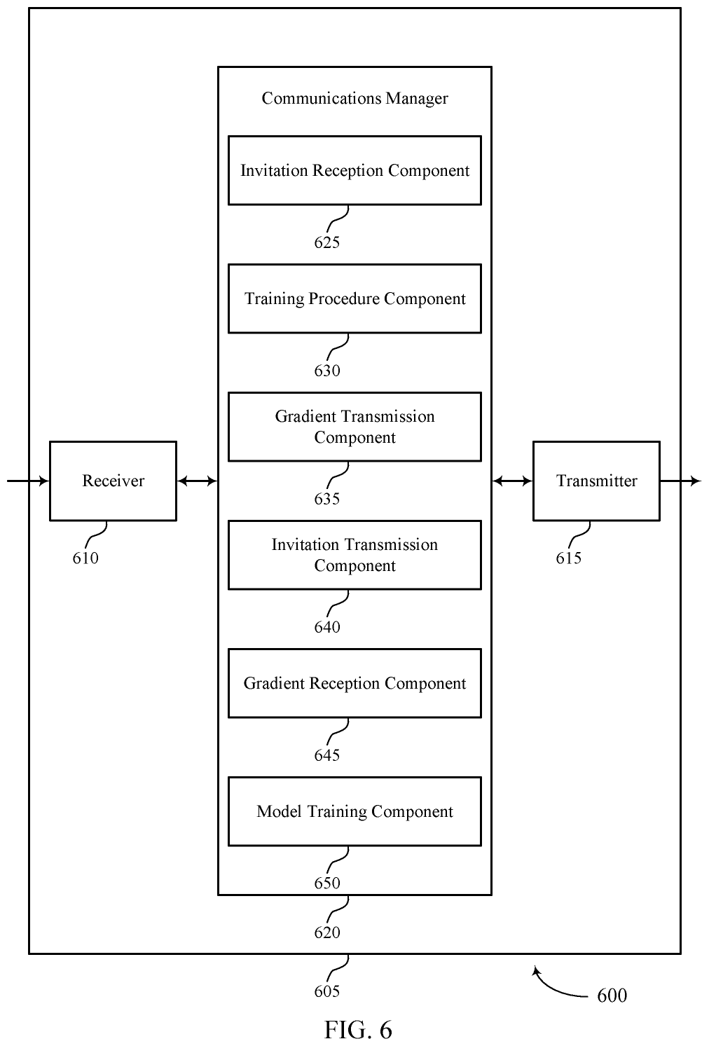

FIG. 6 shows a block diagram 600 of a device 605 that supports OTA aggregation federated learning with non-connected devices in accordance with one or more aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to OTA aggregation federated learning with non-connected devices). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to OTA aggregation federated learning with non-connected devices). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of OTA aggregation federated learning with non-connected devices as described herein. For example, the communications manager 620 may include an invitation reception component 625, a training procedure component 630, a gradient transmission component 635, an invitation transmission component 640, a gradient reception component 645, a model training component 650, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at a UE in accordance with examples as disclosed herein. The invitation reception component 625 may be configured as or otherwise support a means for receiving a first message requesting the UE to perform a federated learning procedure, the first message indicating a machine learning model and a configuration for the federated learning procedure. The training procedure component 630 may be configured as or otherwise support a means for performing, in response to the first message requesting the UE to perform the federated learning procedure, a training procedure using the machine learning model to obtain one or more model parameters based on the configuration for the federated learning procedure. The gradient transmission component 635 may be configured as or otherwise support a means for transmitting a second message indicating one or more gradient values for the one or more model parameters via one or more resources configured for OTA aggregation based on the configuration for the federated learning procedure.

Additionally, or alternatively, the communications manager 620 may support wireless communications at a wireless device in accordance with examples as disclosed herein. The invitation transmission component 640 may be configured as or otherwise support a means for transmitting a first message requesting a set of multiple UEs to perform a federated learning procedure, the first message indicating a machine learning model and a configuration for the federated learning procedure. The gradient reception component 645 may be configured as or otherwise support a means for receiving a set of multiple second messages indicating a set of multiple sets of gradient values for a set of multiple sets of one or more model parameters via one or more resources configured for OTA aggregation based on the configuration for the federated learning procedure. The model training component 650 may be configured as or otherwise support a means for training the machine learning model using the set of multiple sets of one or more model parameters.

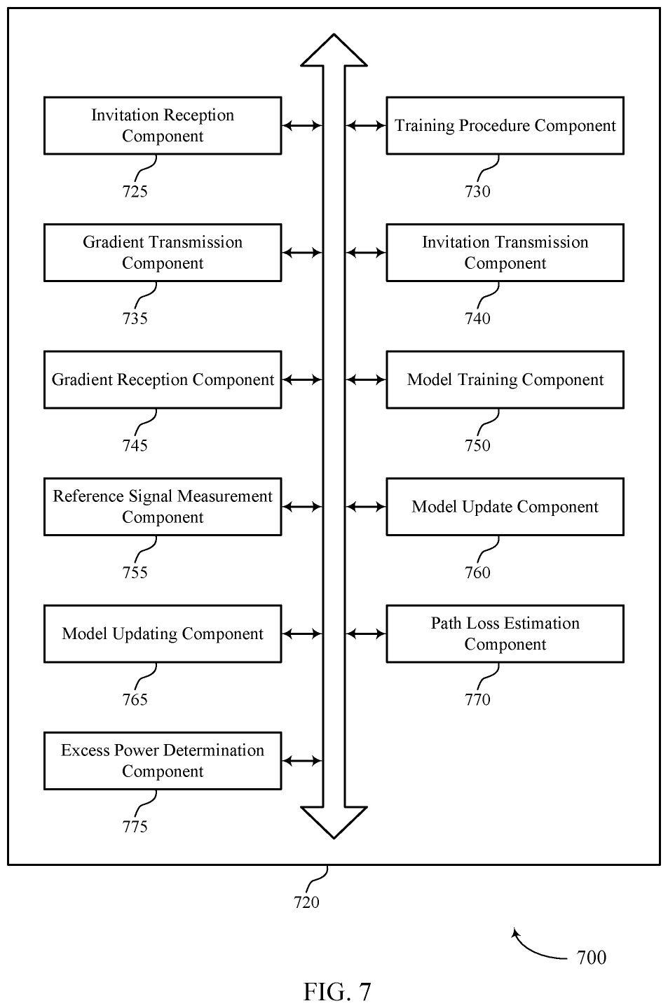

FIG. 7 shows a block diagram 700 of a communications manager 720 that supports OTA aggregation federated learning with non-connected devices in accordance with one or more aspects of the present disclosure. The communications manager 720 may be an example of aspects of a communications manager 520, a communications manager 620, or both, as described herein. The communications manager 720, or various components thereof, may be an example of means for performing various aspects of OTA aggregation federated learning with non-connected devices as described herein. For example, the communications manager 720 may include an invitation reception component 725, a training procedure component 730, a gradient transmission component 735, an invitation transmission component 740, a gradient reception component 745, a model training component 750, a reference signal measurement component 755, a model update component 760, a model updating component 765, a path loss estimation component 770, an excess power determination component 775, or any combination thereof. Each of these components may communicate, directly or indirectly, with one another (e.g., via one or more buses).

The communications manager 720 may support wireless communications at a UE in accordance with examples as disclosed herein. The invitation reception component 725 may be configured as or otherwise support a means for receiving a first message requesting the UE to perform a federated learning procedure, the first message indicating a machine learning model and a configuration for the federated learning procedure. The training procedure component 730 may be configured as or otherwise support a means for performing, in response to the first message requesting the UE to perform the federated learning procedure, a training procedure using the machine learning model to obtain one or more model parameters based on the configuration for the federated learning procedure. The gradient transmission component 735 may be configured as or otherwise support a means for transmitting a second message indicating one or more gradient values for the one or more model parameters via one or more resources configured for OTA aggregation based on the configuration for the federated learning procedure.

In some examples, to support receiving the first message, the invitation reception component 725 may be configured as or otherwise support a means for receiving the first message indicating a range associated with participating in the federated learning procedure, where transmitting the second message is based on determining the UE is within the range.

In some examples, to support receiving the first message, the invitation reception component 725 may be configured as or otherwise support a means for receiving the first message indicating a reference signal and a threshold. In some examples, to support receiving the first message, the reference signal measurement component 755 may be configured as or otherwise support a means for measuring the reference signal to obtain a measurement of the reference signal, where transmitting the second message is based on the measurement of the reference signal exceeding the threshold.

In some examples, to support receiving the first message, the invitation reception component 725 may be configured as or otherwise support a means for receiving the first message indicating a nominal transmit power for transmitting the second message on the one or more resources configured for the OTA aggregation, where transmitting the second message is based on the nominal transmit power.

In some examples, the reference signal measurement component 755 may be configured as or otherwise support a means for receiving an indication of a path loss reference signal and an indication of a reference signal power value. In some examples, the reference signal measurement component 755 may be configured as or otherwise support a means for measuring the path loss reference signal, where transmitting the second message is based on a measurement of the path loss reference signal and the reference signal power value.

In some examples, the path loss estimation component 770 may be configured as or otherwise support a means for receiving an indication of a location of a server. In some examples, the path loss estimation component 770 may be configured as or otherwise support a means for determining a path loss estimate for the second message based on a distance between the UE and the location of the server and a path loss model, where transmitting the second message is based on the path loss estimate.

In some examples, to support receiving the first message, the invitation reception component 725 may be configured as or otherwise support a means for receiving an indication of the machine learning model from a set of multiple machine learning models.

In some examples, to support receiving the first message, the invitation reception component 725 may be configured as or otherwise support a means for receiving an indication of a quantity of layers in a set of multiple layers for the machine learning model, a size of each layer of the set of multiple layers, an order of the set of multiple layers, a connectivity of the set of multiple layers, or any combination thereof, where performing the training procedure is based on the quantity of layers, the size of each layer of the set of multiple layers, the order of the set of multiple layers, the connectivity of the set of multiple layers, or any combination thereof.

In some examples, to support receiving the first message, the invitation reception component 725 may be configured as or otherwise support a means for receiving an indication of a version of the machine learning model from a set of multiple versions of the machine learning model, where performing the training procedure is based on the version of the machine learning model.

In some examples, to support receiving the first message, the invitation reception component 725 may be configured as or otherwise support a means for receiving an indication of an OTA aggregation scheme from a set of multiple OTA aggregation schemes.

In some examples, the invitation reception component 725 may be configured as or otherwise support a means for receiving an indication of a set of multiple occasions in one or more paging frames for the first message requesting the UE to perform the federated learning procedure. In some examples, the invitation reception component 725 may be configured as or otherwise support a means for monitoring for the first message based on the indication of the set of multiple occasions for the first message.

In some examples, the invitation reception component 725 may be configured as or otherwise support a means for receiving a wakeup signal associated with the first message. In some examples, the invitation reception component 725 may be configured as or otherwise support a means for monitoring for the first message requesting the UE to perform the federated learning procedure based on receiving the wakeup signal.

In some examples, the invitation reception component 725 may be configured as or otherwise support a means for decoding the first message based on a paging radio network temporary identifier. In some examples, the invitation reception component 725 may be configured as or otherwise support a means for detecting one or more fields in the first message corresponding to the federated learning procedure, where performing the training procedure is based on detecting the one or more fields.

In some examples, the invitation reception component 725 may be configured as or otherwise support a means for decoding the first message based on a radio network temporary identifier associated with the federated learning procedure, where performing the training procedure is based on decoding the first message based on the radio network temporary identifier associated with the federated learning procedure.

In some examples, to support receiving the first message, the invitation reception component 725 may be configured as or otherwise support a means for receiving the first message during a paging frame or occasion associated with the federated learning procedure, where performing the training procedure is based on receiving the first message during the paging frame or occasion associated with the federated learning procedure.

In some examples, to support receiving the first message, the invitation reception component 725 may be configured as or otherwise support a means for receiving a broadcast transmission or a groupcast transmission on a sidelink channel including sidelink control information requesting the UE to perform the federated learning procedure.

In some examples, to support receiving the first message, the invitation reception component 725 may be configured as or otherwise support a means for receiving the first message indicating one or more criteria for participating in the federated learning procedure, where the one or more criteria are based on a version for the machine learning model, a minimum local dataset size, an acquisition time for a local dataset at the UE, or any combination thereof.

In some examples, to support transmitting the second message, the gradient transmission component 735 may be configured as or otherwise support a means for transmitting the second message via the one or more resources configured for transmission by a set of multiple UEs including the UE, where the set of multiple UEs are scheduled to transmit respective sets of gradient values via the one or more resources in accordance with a common transmit power.

In some examples, the model update component 760 may be configured as or otherwise support a means for receiving a third message indicating an updated version for the machine learning model based on the one or more gradient values for the one or more model parameters. In some examples, the model update component 760 may be configured as or otherwise support a means for updating the machine learning model based on the updated version for the machine learning model.

In some examples, the invitation reception component 725 may be configured as or otherwise support a means for receiving a third message indicating a same version model for the machine learning model and a scalar probability threshold for participating in the federated learning procedure. In some examples, the invitation reception component 725 may be configured as or otherwise support a means for determining to perform the federated learning procedure based on a randomly generated value satisfying the scalar probability threshold. In some examples, the training procedure component 730 may be configured as or otherwise support a means for performing the training procedure using the machine learning model to obtain a second one or more model parameters based on the configuration for the federated learning procedure and the randomly generated value satisfying the scalar probability threshold. In some examples, the gradient transmission component 735 may be configured as or otherwise support a means for transmitting a fourth message indicating a second one or more gradient values for the second one or more model parameters based on the configuration for the federated learning procedure.

In some examples, the UE is operating in an inactive state or an idle state.

In some examples, to support receiving the first message, the gradient transmission component 735 may be configured as or otherwise support a means for receiving the first message configuring the UE to transmit the one or more model parameters in the second message, where the second message indicates the one or more model parameters.

Additionally, or alternatively, the communications manager 720 may support wireless communications at a wireless device in accordance with examples as disclosed herein. The invitation transmission component 740 may be configured as or otherwise support a means for transmitting a first message requesting a set of multiple UEs to perform a federated learning procedure, the first message indicating a machine learning model and a configuration for the federated learning procedure. The gradient reception component 745 may be configured as or otherwise support a means for receiving a set of multiple second messages indicating a set of multiple sets of gradient values for a set of multiple sets of one or more model parameters via one or more resources configured for OTA aggregation based on the configuration for the federated learning procedure. The model training component 750 may be configured as or otherwise support a means for training the machine learning model using the set of multiple sets of one or more model parameters.

In some examples, to support transmitting the first message, the invitation transmission component 740 may be configured as or otherwise support a means for transmitting the first message indicating a range associated with participating in the federated learning procedure, where the set of multiple second messages are received from UEs within the range.

In some examples, to support transmitting the first message, the invitation transmission component 740 may be configured as or otherwise support a means for transmitting an indication of the machine learning model from a set of multiple machine learning models, a version of the machine learning model from a set of multiple versions of the machine learning model, an OTA aggregation scheme from a set of multiple OTA aggregation schemes, a federated learning procedure from a set of multiple federated learning procedures, or any combination thereof.

In some examples, to support transmitting the first message, the invitation transmission component 740 may be configured as or otherwise support a means for transmitting an indication of a quantity of layers in a set of multiple layers for the machine learning model, a size of each layer of the set of multiple layers, an order of the set of multiple layers, a connectivity of the set of multiple layers, or any combination thereof.

In some examples, the model updating component 765 may be configured as or otherwise support a means for transmitting a third message indicating an updated version for the machine learning model based on training the machine learning model. In some examples, the gradient reception component 745 may be configured as or otherwise support a means for receiving a set of multiple fourth messages indicating a second set of multiple sets of gradient values for a second set of multiple sets of one or more model parameters via the one or more resources configured for OTA aggregation based on the configuration for the federated learning procedure.

In some examples, the excess power determination component 775 may be configured as or otherwise support a means for determining a training of the machine learning model using the second set of multiple sets of one or more model parameters is unsuccessful based on an excessive received power of the set of multiple fourth messages. In some examples, the invitation transmission component 740 may be configured as or otherwise support a means for transmitting a fifth message requesting the set of multiple UEs to perform the federated learning procedure, the fifth message indicating the updated version for the machine learning model and a reduced nominal UE transmit power.

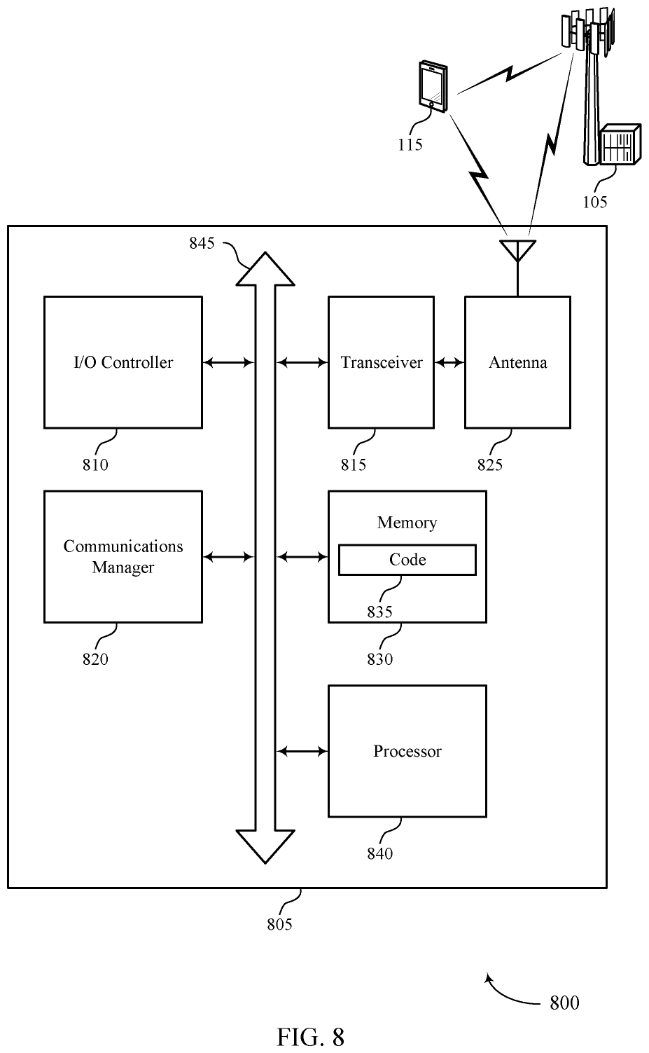

FIG. 8 shows a diagram of a system 800 including a device 805 that supports OTA aggregation federated learning with non-connected devices in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting OTA aggregation federated learning with non-connected devices). For example, the device 805 or a component of the device 805 may include a processor 840 and memory 830 coupled with or to the processor 840, the processor 840 and memory 830 configured to perform various functions described herein.

The communications manager 820 may support wireless communications at a UE in accordance with examples as disclosed herein. For example, the communications manager 820 may be configured as or otherwise support a means for receiving a first message requesting the UE to perform a federated learning procedure, the first message indicating a machine learning model and a configuration for the federated learning procedure. The communications manager 820 may be configured as or otherwise support a means for performing, in response to the first message requesting the UE to perform the federated learning procedure, a training procedure using the machine learning model to obtain one or more model parameters based on the configuration for the federated learning procedure. The communications manager 820 may be configured as or otherwise support a means for transmitting a second message indicating one or more gradient values for the one or more model parameters via one or more resources configured for OTA aggregation based on the configuration for the federated learning procedure.

Additionally, or alternatively, the communications manager 820 may support wireless communications at a wireless device in accordance with examples as disclosed herein. For example, the communications manager 820 may be configured as or otherwise support a means for transmitting a first message requesting a set of multiple UEs to perform a federated learning procedure, the first message indicating a machine learning model and a configuration for the federated learning procedure. The communications manager 820 may be configured as or otherwise support a means for receiving a set of multiple second messages indicating a set of multiple sets of gradient values for a set of multiple sets of one or more model parameters via one or more resources configured for OTA aggregation based on the configuration for the federated learning procedure. The communications manager 820 may be configured as or otherwise support a means for training the machine learning model using the set of multiple sets of one or more model parameters.

By including or configuring the communications manager 820 in accordance with examples as described herein, the device 805 may support techniques for faster machine learning model training and federated learning. These techniques may greatly increase a quantity of UEs 115 participating in a federated learning procedure by enabling non-connected UEs 115 to participate and report gradient values for locally-determined machine learning model parameters. Additionally, the techniques for power control enable non-connected UEs 115 to efficiently report the gradient values using OTA aggregation techniques without disrupting the received power of the gradient values on the OTA aggregation resources at the server.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of OTA aggregation federated learning with non-connected devices as described herein, or the processor 840 and the memory 830 may be otherwise configured to perform or support such operations.

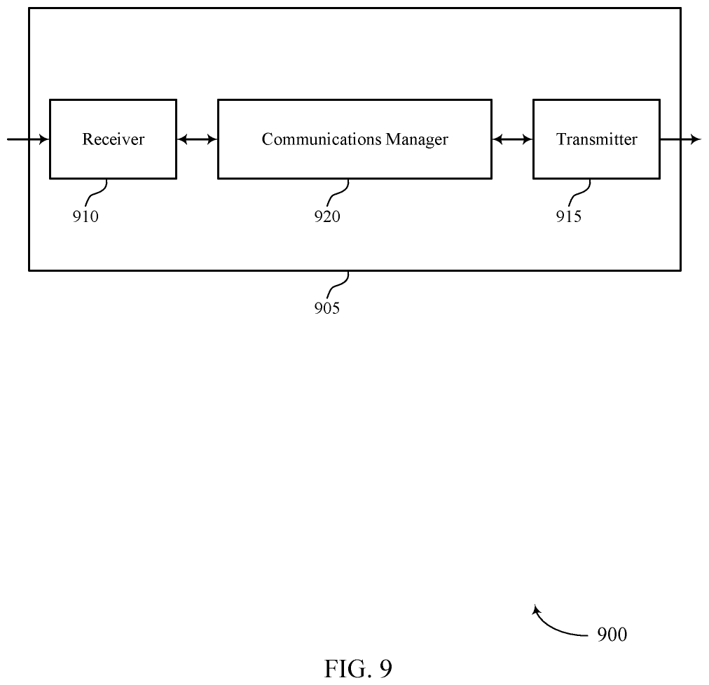

FIG. 9 shows a block diagram 900 of a device 905 that supports OTA aggregation federated learning with non-connected devices in accordance with one or more aspects of the present disclosure. The device 905 may be an example of aspects of a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of OTA aggregation federated learning with non-connected devices as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications at a wireless device in accordance with examples as disclosed herein. For example, the communications manager 920 may be configured as or otherwise support a means for transmitting a first message requesting a set of multiple UEs to perform a federated learning procedure, the first message indicating a machine learning model and a configuration for the federated learning procedure. The communications manager 920 may be configured as or otherwise support a means for receiving a set of multiple second messages indicating a set of multiple sets of gradient values for a set of multiple sets of one or more model parameters via one or more resources configured for OTA aggregation based on the configuration for the federated learning procedure. The communications manager 920 may be configured as or otherwise support a means for training the machine learning model using the set of multiple sets of one or more model parameters.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for more efficient utilization of communication resources by using OTA aggregation for federated learning with non-connected UEs 115. By increasing a quantity of UEs 115 participating in federated learning, these techniques provide a greater reduction of resource overhead and utilization by enabling the non-connected UEs 115 to perform OTA aggregation with efficient power control techniques. Additionally, the power control techniques may reduce a likelihood of a received power at the server impacting or overwhelming the server and rendering a training round useless.

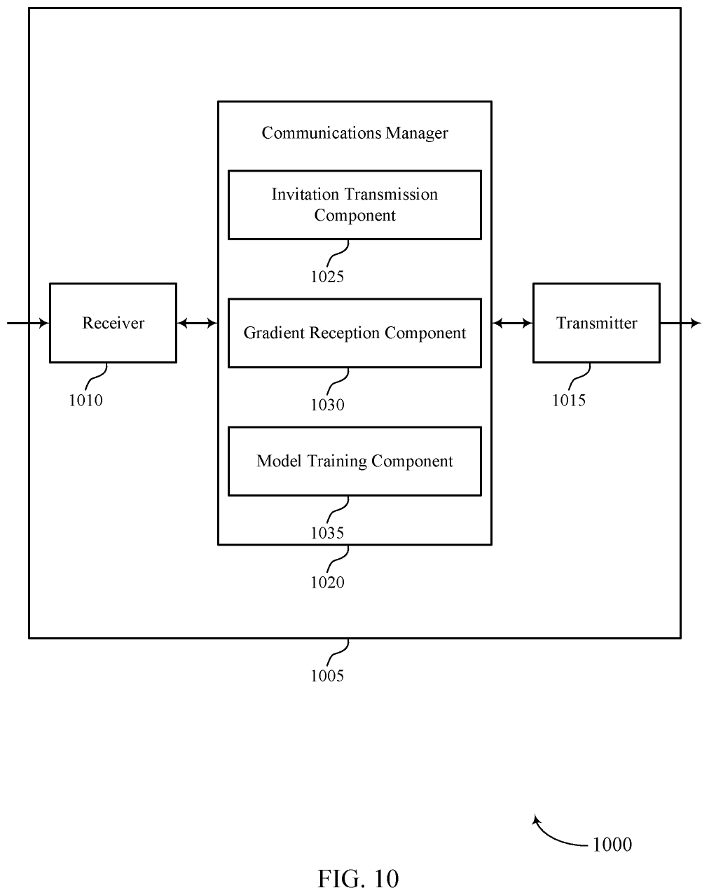

FIG. 10 shows a block diagram 1000 of a device 1005 that supports OTA aggregation federated learning with non-connected devices in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of OTA aggregation federated learning with non-connected devices as described herein. For example, the communications manager 1020 may include an invitation transmission component 1025, a gradient reception component 1030, a model training component 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a wireless device in accordance with examples as disclosed herein. The invitation transmission component 1025 may be configured as or otherwise support a means for transmitting a first message requesting a set of multiple UEs to perform a federated learning procedure, the first message indicating a machine learning model and a configuration for the federated learning procedure. The gradient reception component 1030 may be configured as or otherwise support a means for receiving a set of multiple second messages indicating a set of multiple sets of gradient values for a set of multiple sets of one or more model parameters via one or more resources configured for OTA aggregation based on the configuration for the federated learning procedure. The model training component 1035 may be configured as or otherwise support a means for training the machine learning model using the set of multiple sets of one or more model parameters.

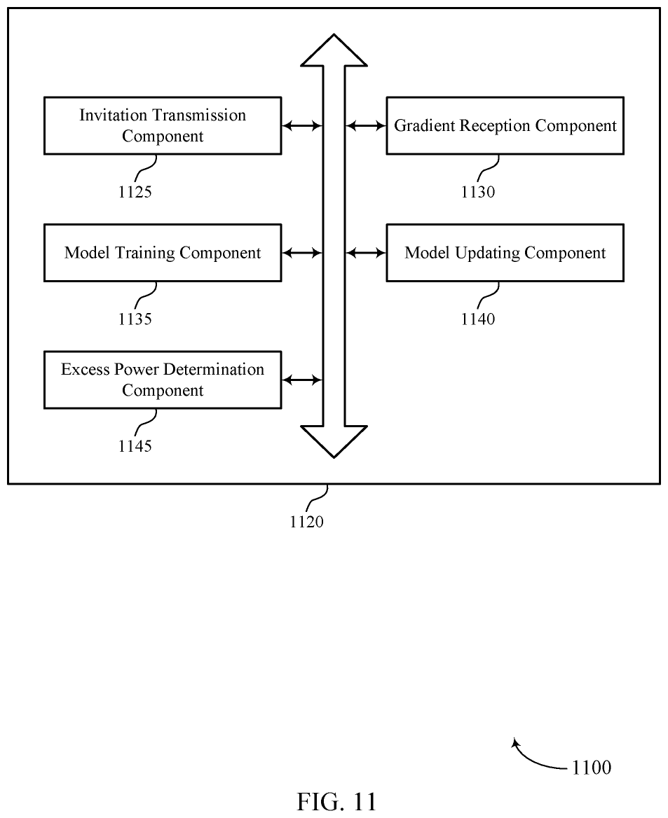

FIG. 11 shows a block diagram 1100 of a communications manager 1120 that supports OTA aggregation federated learning with non-connected devices in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of OTA aggregation federated learning with non-connected devices as described herein. For example, the communications manager 1120 may include an invitation transmission component 1125, a gradient reception component 1130, a model training component 1135, a model updating component 1140, an excess power determination component 1145, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications at a wireless device in accordance with examples as disclosed herein. The invitation transmission component 1125 may be configured as or otherwise support a means for transmitting a first message requesting a set of multiple UEs to perform a federated learning procedure, the first message indicating a machine learning model and a configuration for the federated learning procedure. The gradient reception component 1130 may be configured as or otherwise support a means for receiving a set of multiple second messages indicating a set of multiple sets of gradient values for a set of multiple sets of one or more model parameters via one or more resources configured for OTA aggregation based on the configuration for the federated learning procedure. The model training component 1135 may be configured as or otherwise support a means for training the machine learning model using the set of multiple sets of one or more model parameters.

In some examples, to support transmitting the first message, the invitation transmission component 1125 may be configured as or otherwise support a means for transmitting the first message indicating a range associated with participating in the federated learning procedure, where the set of multiple second messages are received from UEs within the range.

In some examples, to support transmitting the first message, the invitation transmission component 1125 may be configured as or otherwise support a means for transmitting an indication of the machine learning model from a set of multiple machine learning models, a version of the machine learning model from a set of multiple versions of the machine learning model, an OTA aggregation scheme from a set of multiple OTA aggregation schemes, a federated learning procedure from a set of multiple federated learning procedures, or any combination thereof.

In some examples, to support transmitting the first message, the invitation transmission component 1125 may be configured as or otherwise support a means for transmitting an indication of a quantity of layers in a set of multiple layers for the machine learning model, a size of each layer of the set of multiple layers, an order of the set of multiple layers, a connectivity of the set of multiple layers, or any combination thereof.

In some examples, the model updating component 1140 may be configured as or otherwise support a means for transmitting a third message indicating an updated version for the machine learning model based on training the machine learning model. In some examples, the gradient reception component 1130 may be configured as or otherwise support a means for receiving a set of multiple fourth messages indicating a second set of multiple sets of gradient values for a second set of multiple sets of one or more model parameters via the one or more resources configured for OTA aggregation based on the configuration for the federated learning procedure.

In some examples, the excess power determination component 1145 may be configured as or otherwise support a means for determining a training of the machine learning model using the second set of multiple sets of one or more model parameters is unsuccessful based on an excessive received power of the set of multiple fourth messages. In some examples, the invitation transmission component 1125 may be configured as or otherwise support a means for transmitting a fifth message requesting the set of multiple UEs to perform the federated learning procedure, the fifth message indicating the updated version for the machine learning model and a reduced nominal UE transmit power.

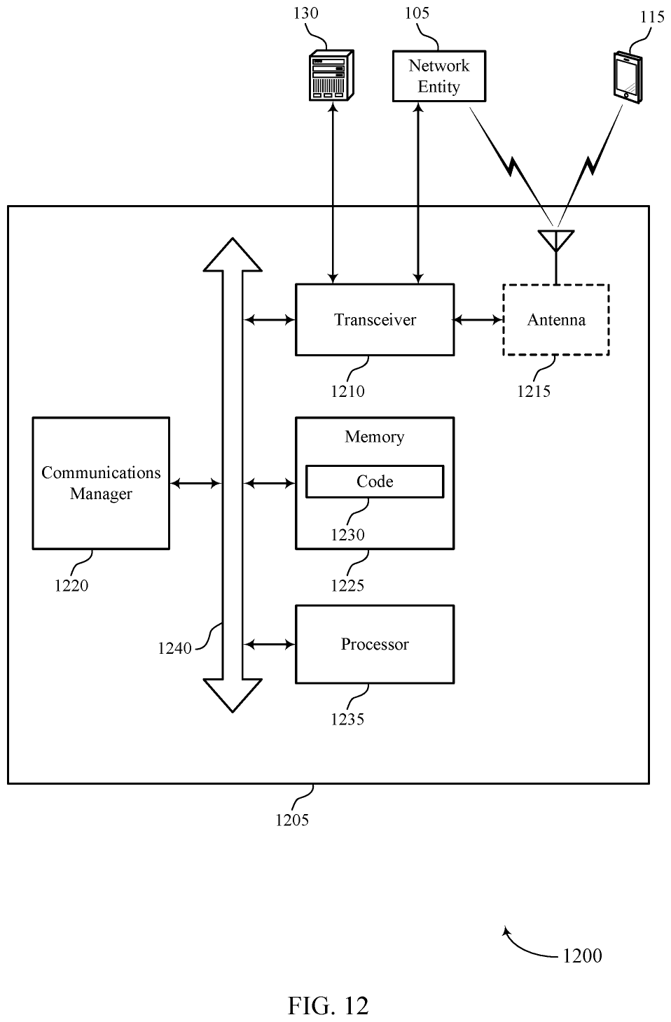

FIG. 12 shows a diagram of a system 1200 including a device 1205 that supports OTA aggregation federated learning with non-connected devices in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, a memory 1225, code 1230, and a processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or memory components (for example, the processor 1235, or the memory 1225, or both), may be included in a chip or chip assembly that is installed in the device 1205. The transceiver 1210, or the transceiver 1210 and one or more antennas 1215 or wired interfaces, where applicable, may be an example of a transmitter 915, a transmitter 1015, a receiver 910, a receiver 1010, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1225 may include RAM and ROM. The memory 1225 may store computer-readable, computer-executable code 1230 including instructions that, when executed by the processor 1235, cause the device 1205 to perform various functions described herein. The code 1230 may be stored in a non-transitory computer-readable medium such as system memory or another type of memory. In some cases, the code 1230 may not be directly executable by the processor 1235 but may cause a computer (e.g., when compiled and executed) to perform functions described herein. In some cases, the memory 1225 may contain, among other things, a BIOS which may control basic hardware or software operation such as the interaction with peripheral components or devices.

The processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1235 may be configured to operate a memory array using a memory controller. In some other cases, a memory controller may be integrated into the processor 1235. The processor 1235 may be configured to execute computer-readable instructions stored in a memory (e.g., the memory 1225) to cause the device 1205 to perform various functions (e.g., functions or tasks supporting OTA aggregation federated learning with non-connected devices). For example, the device 1205 or a component of the device 1205 may include a processor 1235 and memory 1225 coupled with the processor 1235, the processor 1235 and memory 1225 configured to perform various functions described herein. The processor 1235 may be an example of a cloud-computing platform (e.g., one or more physical nodes and supporting software such as operating systems, virtual machines, or container instances) that may host the functions (e.g., by executing code 1230) to perform the functions of the device 1205. The processor 1235 may be any one or more suitable processors capable of executing scripts or instructions of one or more software programs stored in the device 1205 (such as within the memory 1225). In some implementations, the processor 1235 may be a component of a processing system. A processing system may generally refer to a system or series of machines or components that receives inputs and processes the inputs to produce a set of outputs (which may be passed to other systems or components of, for example, the device 1205). For example, a processing system of the device 1205 may refer to a system including the various other components or subcomponents of the device 1205, such as the processor 1235, or the transceiver 1210, or the communications manager 1220, or other components or combinations of components of the device 1205. The processing system of the device 1205 may interface with other components of the device 1205, and may process information received from other components (such as inputs or signals) or output information to other components. For example, a chip or modem of the device 1205 may include a processing system and an interface to output information, or to obtain information, or both. The interface may be implemented as or otherwise include a first interface configured to output information and a second interface configured to obtain information. In some implementations, the first interface may refer to an interface between the processing system of the chip or modem and a transmitter, such that the device 1205 may transmit information output from the chip or modem. In some implementations, the second interface may refer to an interface between the processing system of the chip or modem and a receiver, such that the device 1205 may obtain information or signal inputs, and the information may be passed to the processing system. A person having ordinary skill in the art will readily recognize that the first interface also may obtain information or signal inputs, and the second interface also may output information or signal outputs.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the memory 1225, the code 1230, and the processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communications at a wireless device in accordance with examples as disclosed herein. For example, the communications manager 1220 may be configured as or otherwise support a means for transmitting a first message requesting a set of multiple UEs to perform a federated learning procedure, the first message indicating a machine learning model and a configuration for the federated learning procedure. The communications manager 1220 may be configured as or otherwise support a means for receiving a set of multiple second messages indicating a set of multiple sets of gradient values for a set of multiple sets of one or more model parameters via one or more resources configured for OTA aggregation based on the configuration for the federated learning procedure. The communications manager 1220 may be configured as or otherwise support a means for training the machine learning model using the set of multiple sets of one or more model parameters.

By including or configuring the communications manager 1220 in accordance with examples as described herein, the device 1205 may support techniques for faster machine learning model training and federated learning. These techniques may greatly increase a quantity of UEs 115 participating in a federated learning procedure by enabling non-connected UEs 115 to participate and report gradient values for locally-determined machine learning model parameters. Additionally, the techniques for power control enable non-connected UEs 115 to efficiently report the gradient values using OTA aggregation techniques without disrupting the received power of the gradient values on the OTA aggregation resources at the server.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the processor 1235, the memory 1225, the code 1230, the transceiver 1210, or any combination thereof. For example, the code 1230 may include instructions executable by the processor 1235 to cause the device 1205 to perform various aspects of OTA aggregation federated learning with non-connected devices as described herein, or the processor 1235 and the memory 1225 may be otherwise configured to perform or support such operations.

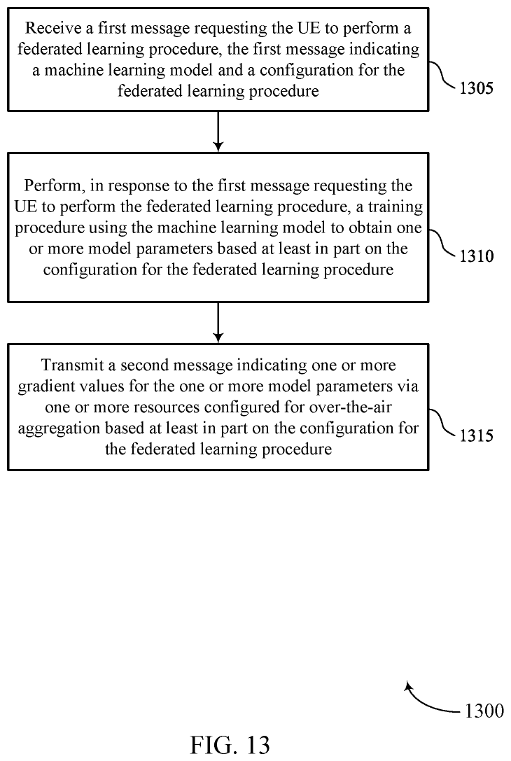

FIG. 13 shows a flowchart illustrating a method 1300 that supports OTA aggregation federated learning with non-connected devices in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving a first message requesting the UE to perform a federated learning procedure, the first message indicating a machine learning model and a configuration for the federated learning procedure. The operations of 1305 may be performed in accordance with examples as disclosed herein. In some examples, aspects of the operations of 1305 may be performed by an invitation reception component 725 as described with reference to FIG. 7.

At 1310, the method may include performing, in response to the first message requesting the UE to perform the federated learning procedure, a training procedure using the machine learning model to obtain one or more model parameters based on the configuration for the federated learning procedure. The operations of 1310 may be performed in accordance with examples as disclosed herein. In some examples, aspects of the operations of 1310 may be performed by a training procedure component 730 as described with reference to FIG. 7.

At 1315, the method may include transmitting a second message indicating one or more gradient values for the one or more model parameters via one or more resources configured for OTA aggregation based on the configuration for the federated learning procedure. The operations of 1315 may be performed in accordance with examples as disclosed herein. In some examples, aspects of the operations of 1315 may be performed by a gradient transmission component 735 as described with reference to FIG. 7.

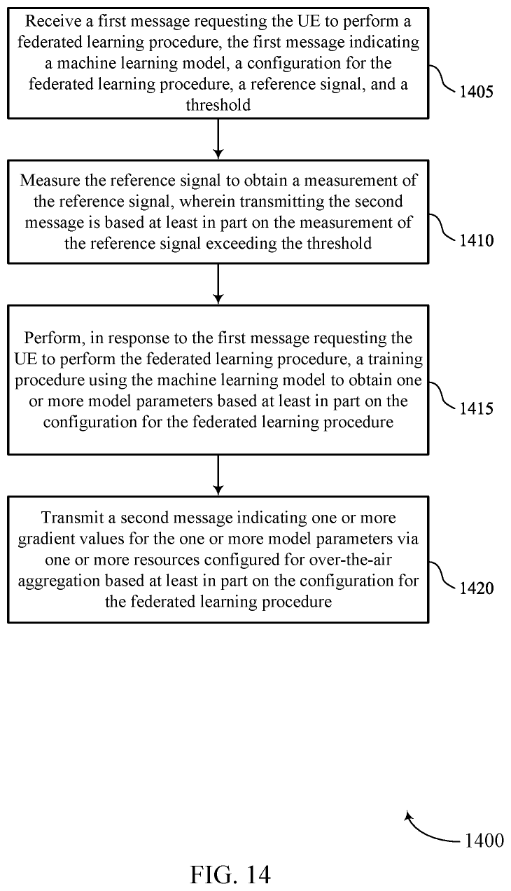

FIG. 14 shows a flowchart illustrating a method 1400 that supports OTA aggregation federated learning with non-connected devices in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include receiving a first message requesting the UE to perform a federated learning procedure, the first message indicating a machine learning model, a configuration for the federated learning procedure, a reference signal, and a threshold. The operations of 1405 may be performed in accordance with examples as disclosed herein. In some examples, aspects of the operations of 1405 may be performed by an invitation reception component 725 as described with reference to FIG. 7.

At 1410, the method may include measuring the reference signal to obtain a measurement of the reference signal, where transmitting the second message is based on the measurement of the reference signal exceeding the threshold. The operations of 1410 may be performed in accordance with examples as disclosed herein. In some examples, aspects of the operations of 1410 may be performed by a reference signal measurement component 755 as described with reference to FIG. 7.

At 1415, the method may include performing, in response to the first message requesting the UE to perform the federated learning procedure, a training procedure using the machine learning model to obtain one or more model parameters based on the configuration for the federated learning procedure. The operations of 1415 may be performed in accordance with examples as disclosed herein. In some examples, aspects of the operations of 1415 may be performed by a training procedure component 730 as described with reference to FIG. 7.

At 1420, the method may include transmitting a second message indicating one or more gradient values for the one or more model parameters via one or more resources configured for OTA aggregation based on the configuration for the federated learning procedure. The operations of 1420 may be performed in accordance with examples as disclosed herein. In some examples, aspects of the operations of 1420 may be performed by a gradient transmission component 735 as described with reference to FIG. 7.

At 1425, the method may include receiving the first message indicating a reference signal and a threshold. The operations of 1425 may be performed in accordance with examples as disclosed herein. In some examples, aspects of the operations of 1425 may be performed by an invitation reception component 725 as described with reference to FIG. 7.

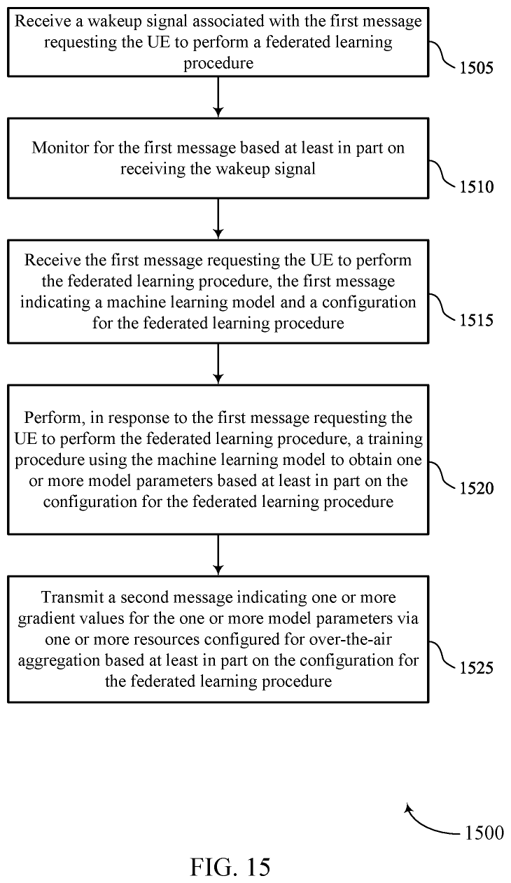

FIG. 15 shows a flowchart illustrating a method 1500 that supports OTA aggregation federated learning with non-connected devices in accordance with one or more aspects of the present disclosure. The operations of the method 1500 may be implemented by a UE or its components as described herein. For example, the operations of the method 1500 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1505, the method may include receiving a wakeup signal associated with a first message requesting the UE to perform a federated learning procedure. The operations of 1505 may be performed in accordance with examples as disclosed herein. In some examples, aspects of the operations of 1505 may be performed by an invitation reception component 725 as described with reference to FIG. 7.

At 1510, the method may include monitoring for the first message based on receiving the wakeup signal. The operations of 1510 may be performed in accordance with examples as disclosed herein. In some examples, aspects of the operations of 1510 may be performed by an invitation reception component 725 as described with reference to FIG. 7.

At 1515, the method may include receiving the first message requesting the UE to perform the federated learning procedure, the first message indicating a machine learning model and a configuration for the federated learning procedure. The operations of 1515 may be performed in accordance with examples as disclosed herein. In some examples, aspects of the operations of 1515 may be performed by an invitation reception component 725 as described with reference to FIG. 7.

At 1520, the method may include performing, in response to the first message requesting the UE to perform the federated learning procedure, a training procedure using the machine learning model to obtain one or more model parameters based on the configuration for the federated learning procedure. The operations of 1520 may be performed in accordance with examples as disclosed herein. In some examples, aspects of the operations of 1520 may be performed by a training procedure component 730 as described with reference to FIG. 7.

At 1525, the method may include transmitting a second message indicating one or more gradient values for the one or more model parameters via one or more resources configured for OTA aggregation based on the configuration for the federated learning procedure. The operations of 1525 may be performed in accordance with examples as disclosed herein. In some examples, aspects of the operations of 1525 may be performed by a gradient transmission component 735 as described with reference to FIG. 7.

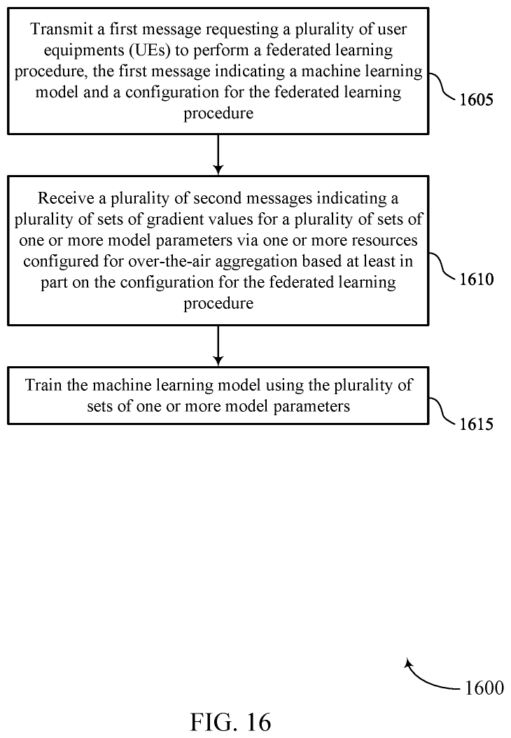

FIG. 16 shows a flowchart illustrating a method 1600 that supports OTA aggregation federated learning with non-connected devices in accordance with one or more aspects of the present disclosure. The operations of the method 1600 may be implemented by a UE or a network entity or its components as described herein. For example, the operations of the method 1600 may be performed by a UE 115 as described with reference to FIGS. 1 through 8 or a network entity as described with reference to FIGS. 1 through 4 and 9 through 12. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1605, the method may include transmitting a first message requesting a set of multiple UEs to perform a federated learning procedure, the first message indicating a machine learning model and a configuration for the federated learning procedure. The operations of 1605 may be performed in accordance with examples as disclosed herein. In some examples, aspects of the operations of 1605 may be performed by an invitation transmission component 740 or an invitation transmission component 1125 as described with reference to FIGS. 7 and 11.

At 1610, the method may include receiving a set of multiple second messages indicating a set of multiple sets of gradient values for a set of multiple sets of one or more model parameters via one or more resources configured for OTA aggregation based on the configuration for the federated learning procedure. The operations of 1610 may be performed in accordance with examples as disclosed herein. In some examples, aspects of the operations of 1610 may be performed by a gradient reception component 745 or a gradient reception component 1130 as described with reference to FIGS. 7 and 11.

At 1615, the method may include training the machine learning model using the set of multiple sets of one or more model parameters. The operations of 1615 may be performed in accordance with examples as disclosed herein. In some examples, aspects of the operations of 1615 may be performed by a model training component 750 or a model training component 1135 as described with reference to FIGS. 7 and 11.

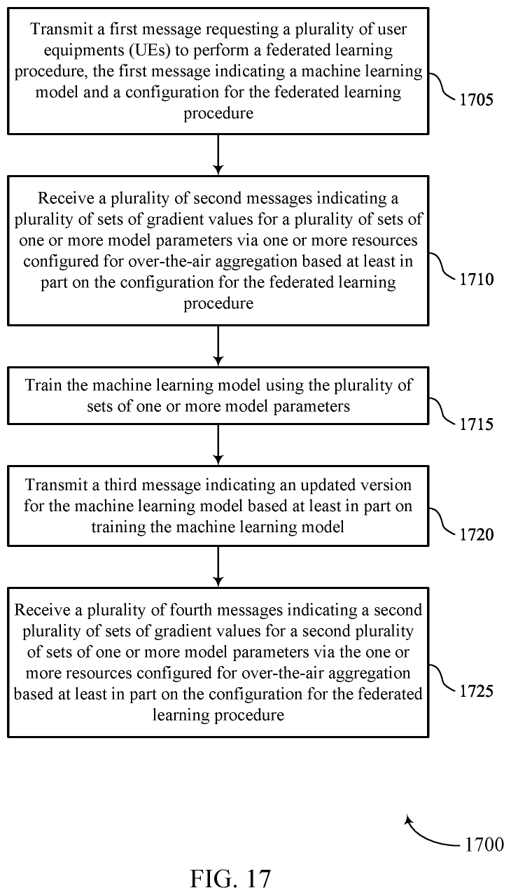

FIG. 17 shows a flowchart illustrating a method 1700 that supports OTA aggregation federated learning with non-connected devices in accordance with one or more aspects of the present disclosure. The operations of the method 1700 may be implemented by a UE or a network entity or its components as described herein. For example, the operations of the method 1700 may be performed by a UE 115 as described with reference to FIGS. 1 through 8 or a network entity as described with reference to FIGS. 1 through 4 and 9 through 12. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1705, the method may include transmitting a first message requesting a set of multiple UEs to perform a federated learning procedure, the first message indicating a machine learning model and a configuration for the federated learning procedure. The operations of 1705 may be performed in accordance with examples as disclosed herein. In some examples, aspects of the operations of 1705 may be performed by an invitation transmission component 740 or an invitation transmission component 1125 as described with reference to FIGS. 7 and 11.

At 1710, the method may include receiving a set of multiple second messages indicating a set of multiple sets of gradient values for a set of multiple sets of one or more model parameters via one or more resources configured for OTA aggregation based on the configuration for the federated learning procedure. The operations of 1710 may be performed in accordance with examples as disclosed herein. In some examples, aspects of the operations of 1710 may be performed by a gradient reception component 745 or a gradient reception component 1130 as described with reference to FIGS. 7 and 11.

At 1715, the method may include training the machine learning model using the set of multiple sets of one or more model parameters. The operations of 1715 may be performed in accordance with examples as disclosed herein. In some examples, aspects of the operations of 1715 may be performed by a model training component 750 or a model training component 1135 as described with reference to FIGS. 7 and 11.

At 1720, the method may include transmitting a third message indicating an updated version for the machine learning model based on training the machine learning model. The operations of 1720 may be performed in accordance with examples as disclosed herein. In some examples, aspects of the operations of 1720 may be performed by a model updating component 765 or a model updating component 1140 as described with reference to FIGS. 7 and 11.

At 1725, the method may include receiving a set of multiple fourth messages indicating a second set of multiple sets of gradient values for a second set of multiple sets of one or more model parameters via the one or more resources configured for OTA aggregation based on the configuration for the federated learning procedure. The operations of 1725 may be performed in accordance with examples as disclosed herein. In some examples, aspects of the operations of 1725 may be performed by a gradient reception component 745 or a gradient reception component 1130 as described with reference to FIGS. 7 and 11.

The following provides an overview of aspects of the present disclosure:

Aspect 1: A method for wireless communications at a UE, comprising: receiving a first message requesting the UE to perform a federated learning procedure, the first message indicating a machine learning model and a configuration for the federated learning procedure: performing, in response to the first message requesting the UE to perform the federated learning procedure, a training procedure using the machine learning model to obtain one or more model parameters based at least in part on the configuration for the federated learning procedure; and transmitting a second message indicating one or more gradient values for the one or more model parameters via one or more resources configured for over-the-air aggregation based at least in part on the configuration for the federated learning procedure.

Aspect 2: The method of aspect 1, wherein receiving the first message comprises: receiving the first message indicating a range associated with participating in the federated learning procedure, wherein transmitting the second message is based at least in part on determining the UE is within the range.

Aspect 3: The method of any of aspects 1 through 2, wherein receiving the first message comprises: receiving the first message indicating a reference signal and a threshold; and measuring the reference signal to obtain a measurement of the reference signal, wherein transmitting the second message is based at least in part on the measurement of the reference signal exceeding the threshold.

Aspect 4: The method of any of aspects 1 through 3, wherein receiving the first message comprises: receiving the first message indicating a nominal transmit power for transmitting the second message on the one or more resources configured for the over-the-air aggregation, wherein transmitting the second message is based at least in part on the nominal transmit power.

Aspect 5: The method of aspect 4, further comprising: receiving an indication of a path loss reference signal and an indication of a reference signal power value; and measuring the path loss reference signal, wherein transmitting the second message is based at least in part on a measurement of the path loss reference signal and the reference signal power value.

Aspect 6: The method of any of aspects 4 through 5, further comprising: receiving an indication of a location of a server; and determining a path loss estimate for the second message based at least in part on a distance between the UE and the location of the server and a path loss model, wherein transmitting the second message is based at least in part on the path loss estimate.

Aspect 7: The method of any of aspects 1 through 6, wherein receiving the first message comprises: receiving an indication of the machine learning model from a plurality of machine learning models.

Aspect 8: The method of any of aspects 1 through 7, wherein receiving the first message comprises: receiving an indication of a quantity of layers in a plurality of layers for the machine learning model, a size of each layer of the plurality of layers, an order of the plurality of layers, a connectivity of the plurality of layers, or any combination thereof, wherein performing the training procedure is based at least in part on the quantity of layers, the size of each layer of the plurality of layers, the order of the plurality of layers, the connectivity of the plurality of layers, or any combination thereof.

Aspect 9: The method of any of aspects 1 through 8, wherein receiving the first message comprises: receiving an indication of a version of the machine learning model from a plurality of versions of the machine learning model, wherein performing the training procedure is based at least in part on the version of the machine learning model.

Aspect 10: The method of any of aspects 1 through 9, wherein receiving the first message comprises: receiving an indication of an over-the-air aggregation scheme from a plurality of over-the-air aggregation schemes.

Aspect 11: The method of any of aspects 1 through 10, further comprising: receiving an indication of a plurality of occasions in one or more paging frames for the first message requesting the UE to perform the federated learning procedure; and monitoring for the first message based at least in part on the indication of the plurality of occasions for the first message.

Aspect 12: The method of any of aspects 1 through 11, further comprising: receiving a wakeup signal associated with the first message; and monitoring for the first message requesting the UE to perform the federated learning procedure based at least in part on receiving the wakeup signal.

Aspect 13: The method of any of aspects 1 through 12, further comprising: decoding the first message based at least in part on a paging radio network temporary identifier; and detecting one or more fields in the first message corresponding to the federated learning procedure, wherein performing the training procedure is based at least in part on detecting the one or more fields.

Aspect 14: The method of any of aspects 1 through 13, further comprising: decoding the first message based at least in part on a radio network temporary identifier associated with the federated learning procedure, wherein performing the training procedure is based at least in part on decoding the first message based at least in part on the radio network temporary identifier associated with the federated learning procedure.

Aspect 15: The method of any of aspects 1 through 14, wherein receiving the first message comprises: receiving the first message during a paging frame or occasion associated with the federated learning procedure, wherein performing the training procedure is based at least in part on receiving the first message during the paging frame or occasion associated with the federated learning procedure.

Aspect 16: The method of any of aspects 1 through 15, wherein receiving the first message comprises: receiving a broadcast transmission or a groupcast transmission on a sidelink channel including sidelink control information requesting the UE to perform the federated learning procedure.

Aspect 17: The method of any of aspects 1 through 16, wherein receiving the first message comprises: receiving the first message indicating one or more criteria for participating in the federated learning procedure, wherein the one or more criteria are based at least in part on a version for the machine learning model, a minimum local dataset size, an acquisition time for a local dataset at the UE, or any combination thereof.

Aspect 18: The method of any of aspects 1 through 17, wherein transmitting the second message comprises: transmitting the second message via the one or more resources configured for transmission by a plurality of UEs including the UE, wherein the plurality of UEs are scheduled to transmit respective sets of gradient values via the one or more resources in accordance with a common transmit power.

Aspect 19: The method of any of aspects 1 through 18, further comprising: receiving a third message indicating an updated version for the machine learning model based at least in part on the one or more gradient values for the one or more model parameters; and updating the machine learning model based at least in part on the updated version for the machine learning model.

Aspect 20: The method of any of aspects 1 through 19, further comprising: receiving a third message indicating a same version model for the machine learning model and a scalar probability threshold for participating in the federated learning procedure: determining to perform the federated learning procedure based at least in part on a randomly generated value satisfying the scalar probability threshold; performing the training procedure using the machine learning model to obtain a second one or more model parameters based at least in part on the configuration for the federated learning procedure and the randomly generated value satisfying the scalar probability threshold; and transmitting a fourth message indicating a second one or more gradient values for the second one or more model parameters based at least in part on the configuration for the federated learning procedure.

Aspect 21: The method of any of aspects 1 through 20, wherein the UE is operating in an inactive state or an idle state.

Aspect 22: The method of any of aspects 1 through 21, wherein receiving the first message comprises: receiving the first message configuring the UE to transmit the one or more model parameters in the second message, wherein the second message indicates the one or more model parameters.

Aspect 23: A method for wireless communications at a wireless device, comprising: transmitting a first message requesting a plurality of user equipments (UEs) to perform a federated learning procedure, the first message indicating a machine learning model and a configuration for the federated learning procedure: receiving a plurality of second messages indicating a plurality of sets of gradient values for a plurality of sets of one or more model parameters via one or more resources configured for over-the-air aggregation based at least in part on the configuration for the federated learning procedure; and training the machine learning model using the plurality of sets of one or more model parameters.

Aspect 24: The method of aspect 23, wherein transmitting the first message comprises: transmitting the first message indicating a range associated with participating in the federated learning procedure, wherein the plurality of second messages are received from UEs within the range.

Aspect 25: The method of any of aspects 23 through 24, wherein transmitting the first message comprises: transmitting an indication of the machine learning model from a plurality of machine learning models, a version of the machine learning model from a plurality of versions of the machine learning model, an over-the-air aggregation scheme from a plurality of over-the-air aggregation schemes, a federated learning procedure from a plurality of federated learning procedures, or any combination thereof.

Aspect 26: The method of any of aspects 23 through 25, wherein transmitting the first message comprises: transmitting an indication of a quantity of layers in a plurality of layers for the machine learning model, a size of each layer of the plurality of layers, an order of the plurality of layers, a connectivity of the plurality of layers, or any combination thereof.

Aspect 27: The method of any of aspects 23 through 26, further comprising: transmitting a third message indicating an updated version for the machine learning model based at least in part on training the machine learning model; and receiving a plurality of fourth messages indicating a second plurality of sets of gradient values for a second plurality of sets of one or more model parameters via the one or more resources configured for over-the-air aggregation based at least in part on the configuration for the federated learning procedure.

Aspect 28: The method of aspect 27, further comprising: determining a training of the machine learning model using the second plurality of sets of one or more model parameters is unsuccessful based at least in part on an excessive received power of the plurality of fourth messages; and transmitting a fifth message requesting the plurality of UEs to perform the federated learning procedure, the fifth message indicating the updated version for the machine learning model and a reduced nominal UE transmit power.

Aspect 29: An apparatus for wireless communications at a UE, comprising a processor; memory coupled with the processor; and one or more instructions stored in the memory and executable by the processor to cause the apparatus to perform a method of any of aspects 1 through 22.

Aspect 30: An apparatus for wireless communications at a UE, comprising at least one means for performing a method of any of aspects 1 through 22.

Aspect 31: A non-transitory computer-readable medium storing code for wireless communications at a UE, the code comprising one or more instructions executable by a processor to perform a method of any of aspects 1 through 22.

Aspect 32: An apparatus for wireless communications at a wireless device, comprising a processor; memory coupled with the processor; and instructions stored in the memory and executable by the processor to cause the apparatus to perform a method of any of aspects 23 through 28.

Aspect 33: An apparatus for wireless communications at a wireless device, comprising at least one means for performing a method of any of aspects 23 through 28.

Aspect 34: A non-transitory computer-readable medium storing code for wireless communications at a wireless device, the code comprising instructions executable by a processor to perform a method of any of aspects 23 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a user equipment (UE), comprising:
a processor;
memory coupled with the processor; and
one or more instructions stored in the memory and executable by the processor to cause the apparatus to, based at least in part on the one or more instructions;
receive a first message requesting the UE to perform a federated learning procedure, the first message indicating a machine learning model and a configuration for the federated learning procedure;
perform, in response to the first message requesting the UE to perform the federated learning procedure, a training procedure using the machine learning model to obtain one or more model parameters based at least in part on the configuration for the federated learning procedure; and
transmit a second message indicating one or more gradient values for the one or more model parameters via one or more resources configured for over-the-air aggregation based at least in part on the configuration for the federated learning procedure.

2. The apparatus of claim 1, wherein the one or more instructions to receive the first message are executable by the processor to cause the apparatus to:
receive the first message indicating a range associated with participating in the federated learning procedure, wherein transmitting the second message is based at least in part on determining the UE is within the range.

3. The apparatus of claim 1, wherein the one or more instructions to receive the first message are executable by the processor to cause the apparatus to:
receive the first message indicating a reference signal and a threshold; and
measure the reference signal to obtain a measurement of the reference signal, wherein transmitting the second message is based at least in part on the measurement of the reference signal exceeding the threshold.

4. The apparatus of claim 1, wherein the one or more instructions to receive the first message are executable by the processor to cause the apparatus to:
receive the first message indicating a nominal transmit power for transmitting the second message on the one or more resources configured for the over-the-air aggregation, wherein transmitting the second message is based at least in part on the nominal transmit power.

5. The apparatus of claim 4, wherein the one or more instructions are further executable by the processor to cause the apparatus to:
receive an indication of a path loss reference signal and an indication of a reference signal power value; and
measure the path loss reference signal, wherein transmitting the second message is based at least in part on a measurement of the path loss reference signal and the reference signal power value.

6. The apparatus of claim 4, wherein the one or more instructions are further executable by the processor to cause the apparatus to:
receive an indication of a location of a server; and
determine a path loss estimate for the second message based at least in part on a distance between the UE and the location of the server and a path loss model, wherein transmitting the second message is based at least in part on the path loss estimate.

7. The apparatus of claim 1, wherein the one or more instructions to receive the first message are executable by the processor to cause the apparatus to:
receive an indication of the machine learning model from a plurality of machine learning models.

8. The apparatus of claim 1, wherein the one or more instructions to receive the first message are executable by the processor to cause the apparatus to:
receive an indication of a quantity of layers in a plurality of layers for the machine learning model, a size of each layer of the plurality of layers, an order of the plurality of layers, a connectivity of the plurality of layers, or any combination thereof, wherein performing the training procedure is based at least in part on the quantity of layers, the size of each layer of the plurality of layers, the order of the plurality of layers, the connectivity of the plurality of layers, or any combination thereof.

9. The apparatus of claim 1, wherein the one or more instructions to receive the first message are executable by the processor to cause the apparatus to:
receive an indication of a version of the machine learning model from a plurality of versions of the machine learning model, wherein performing the training procedure is based at least in part on the version of the machine learning model.

10. The apparatus of claim 1, wherein the one or more instructions to receive the first message are executable by the processor to cause the apparatus to:
receive an indication of an over-the-air aggregation scheme from a plurality of over-the-air aggregation schemes.

11. The apparatus of claim 1, wherein the one or more instructions are further executable by the processor to cause the apparatus to:
receive an indication of a plurality of occasions in one or more paging frames for the first message requesting the UE to perform the federated learning procedure; and
monitor for the first message based at least in part on the indication of the plurality of occasions for the first message.

12. The apparatus of claim 1, wherein the one or more instructions are further executable by the processor to cause the apparatus to:
receive a wakeup signal associated with the first message; and
monitor for the first message requesting the UE to perform the federated learning procedure based at least in part on receiving the wakeup signal.

13. The apparatus of claim 1, wherein the one or more instructions are further executable by the processor to cause the apparatus to:
decode the first message based at least in part on a paging radio network temporary identifier; and
detect one or more fields in the first message corresponding to the federated learning procedure, wherein performing the training procedure is based at least in part on detecting the one or more fields.

14. The apparatus of claim 1, wherein the one or more instructions are further executable by the processor to cause the apparatus to:
decode the first message based at least in part on a radio network temporary identifier associated with the federated learning procedure, wherein performing the training procedure is based at least in part on decoding the first message based at least in part on the radio network temporary identifier associated with the federated learning procedure.

15. The apparatus of claim 1, wherein the one or more instructions to receive the first message are executable by the processor to cause the apparatus to:
receive the first message during a paging frame or occasion associated with the federated learning procedure, wherein performing the training procedure is based at least in part on receiving the first message during the paging frame or occasion associated with the federated learning procedure.

16. The apparatus of claim 1, wherein the one or more instructions to receive the first message are executable by the processor to cause the apparatus to:
receive a broadcast transmission or a groupcast transmission on a sidelink channel including sidelink control information requesting the UE to perform the federated learning procedure.

17. The apparatus of claim 1, wherein the one or more instructions to receive the first message are executable by the processor to cause the apparatus to:
receive the first message indicating one or more criteria for participating in the federated learning procedure, wherein the one or more criteria are based at least in part on a version for the machine learning model, a minimum local dataset size, an acquisition time for a local dataset at the UE, or any combination thereof.

18. The apparatus of claim 1, wherein the one or more instructions to transmit the second message are executable by the processor to cause the apparatus to:
transmit the second message via the one or more resources configured for transmission by a plurality of UEs including the UE, wherein the plurality of UEs are scheduled to transmit respective sets of gradient values via the one or more resources in accordance with a common transmit power.

19. The apparatus of claim 1, wherein the one or more instructions are further executable by the processor to cause the apparatus to:
receive a third message indicating an updated version for the machine learning model based at least in part on the one or more gradient values for the one or more model parameters; and
update the machine learning model based at least in part on the updated version for the machine learning model.

20. The apparatus of claim 1, wherein the one or more instructions are further executable by the processor to cause the apparatus to:
receive a third message indicating a same version model for the machine learning model and a scalar probability threshold for participating in the federated learning procedure;
determine to perform the federated learning procedure based at least in part on a randomly generated value satisfying the scalar probability threshold;
perform the training procedure using the machine learning model to obtain a second one or more model parameters based at least in part on the configuration for the federated learning procedure and the randomly generated value satisfying the scalar probability threshold; and
transmit a fourth message indicating a second one or more gradient values for the second one or more model parameters based at least in part on the configuration for the federated learning procedure.

21. The apparatus of claim 1, wherein the UE is operating in an inactive state or an idle state.

22. The apparatus of claim 1, wherein the one or more instructions to receive the first message are executable by the processor to cause the apparatus to:
receive the first message configuring the UE to transmit the one or more model parameters in the second message, wherein the second message indicates the one or more model parameters.

23. An apparatus for wireless communications at a wireless device, comprising:
a processor;
memory coupled with the processor; and
one or more instructions stored in the memory and executable by the processor to cause the apparatus to, based at least in part on the one or more instructions;
transmit a first message requesting a plurality of user equipments (UEs) to perform a federated learning procedure, the first message indicating a machine learning model and a configuration for the federated learning procedure;
receive a plurality of second messages indicating a plurality of sets of gradient values for a plurality of sets of one or more model parameters via one or more resources configured for over-the-air aggregation based at least in part on the configuration for the federated learning procedure; and
train the machine learning model using the plurality of sets of one or more model parameters.

24. The apparatus of claim 23, wherein the one or more instructions to transmit the first message are executable by the processor to cause the apparatus to:
transmit the first message indicating a range associated with participating in the federated learning procedure, wherein the plurality of second messages are received from UEs within the range.

25. The apparatus of claim 23, wherein the one or more instructions to transmit the first message are executable by the processor to cause the apparatus to:
transmit an indication of the machine learning model from a plurality of machine learning models, a version of the machine learning model from a plurality of versions of the machine learning model, an over-the-air aggregation scheme from a plurality of over-the-air aggregation schemes, a federated learning procedure from a plurality of federated learning procedures, or any combination thereof.

26. The apparatus of claim 23, wherein the one or more instructions to transmit the first message are executable by the processor to cause the apparatus to:
transmit an indication of a quantity of layers in a plurality of layers for the machine learning model, a size of each layer of the plurality of layers, an order of the plurality of layers, a connectivity of the plurality of layers, or any combination thereof.

27. The apparatus of claim 23, wherein the one or more instructions are further executable by the processor to cause the apparatus to:
transmit a third message indicating an updated version for the machine learning model based at least in part on training the machine learning model; and
receive a plurality of fourth messages indicating a second plurality of sets of gradient values for a second plurality of sets of one or more model parameters via the one or more resources configured for over-the-air aggregation based at least in part on the configuration for the federated learning procedure.

28. The apparatus of claim 27, wherein the one or more instructions are further executable by the processor to cause the apparatus to:
determine a training of the machine learning model using the second plurality of sets of one or more model parameters is unsuccessful based at least in part on an excessive received power of the plurality of fourth messages; and
transmit a fifth message requesting the plurality of UEs to perform the federated learning procedure, the fifth message indicating the updated version for the machine learning model and a reduced nominal UE transmit power.

29. A method for wireless communications at a user equipment (UE), comprising:
receiving a first message requesting the UE to perform a federated learning procedure, the first message indicating a machine learning model and a configuration for the federated learning procedure;
performing, in response to the first message requesting the UE to perform the federated learning procedure, a training procedure using the machine learning model to obtain one or more model parameters based at least in part on the configuration for the federated learning procedure; and
transmitting a second message indicating one or more gradient values for the one or more model parameters via one or more resources configured for over-the-air aggregation based at least in part on the configuration for the federated learning procedure.

30. A method for wireless communications at a wireless device, comprising:
transmitting a first message requesting a plurality of user equipments (UEs) to perform a federated learning procedure, the first message indicating a machine learning model and a configuration for the federated learning procedure;
receiving a plurality of second messages indicating a plurality of sets of gradient values for a plurality of sets of one or more model parameters via one or more resources configured for over-the-air aggregation based at least in part on the configuration for the federated learning procedure; and
training the machine learning model using the plurality of sets of one or more model parameters.
